(19) United States
(12) Patent Application Publication
(10) Pub. No.: US 2025/0206065 A1
(43) Pub. Date: Jun. 26, 2025

(54) TIRE

(71) Applicant: Sumitomo Rubber Industries, Ltd., Kobe-shi (JP)

(72) Inventor: Ryota IKEDA, Kobe-shi (JP)

(73) Assignee: Sumitomo Rubber Industries, Ltd., Kobe-shi (JP)

(21) Appl. No.: 18/968,644

(22) Filed: Dec. 4, 2024

(30) Foreign Application Priority Data
Dec. 25, 2023 (JP) 2023-218596

(51) Int. Cl. B60C 11/00; B60C 11/03

(52) U.S. Cl. CPC B60C 11/005; B60C 11/0008; B60C 2011/0025; B60C 2011/0033; B60C 2011/0341

(57) ABSTRACT

A tire can include a tread and a belt. Each end of a base layer of the tread can be located axially inward of an end of the belt. The tread can include circumferential grooves, thereby forming land portions including a crown land portion, a shoulder land portion, and a middle land portion. A cap layer proportion ARc of the crown land portion can be not less than 1.5 and not greater than 3.5. A cap layer proportion ARm of the middle land portion can be equal to or higher than the cap layer proportion ARc of the crown land portion. A cap layer proportion ARs of the shoulder land portion can be higher than the cap layer proportion ARm of the middle land portion and not less than 5.0 and not greater than 9.5.

### CROSS-REFERENCE TO RELATED APPLICATION

The present application claims priority to Japanese patent application JP 2023-218596, filed on Dec. 25, 2023, the entire content of which is incorporated herein by reference in its entirety.

### BACKGROUND

### Field

The present disclosure relates to a tire. Specifically, the present disclosure relates to a tire that is mountable to a passenger car.

### Background

From the viewpoint of consideration for the environment, reduction of rolling resistance may be required for tires that are mounted to vehicles. Therefore, for example, decreasing the number of components included in a tire, decreasing the thicknesses of the components, using rubbers having a low loss tangent as the materials forming the components, etc., may be considered (for example, Japanese Laid-Open Patent Publication No. 2021-120242).

The tread of a tire comes into contact with a road surface. A cap layer becomes worn, and eventually a base layer becomes exposed. During limit running (e.g., when a vehicle corners at a high speed), a shoulder portion of the tire (specifically, a tread portion) may also come into contact with the road surface.

During limit running, a relatively large load may act on the shoulder portion. The base layer may be more brittle than the cap layer. If the cap layer becomes worn and the base layer becomes exposed, the tread may peel off. Therefore, various measures may be taken for tires to prevent treads from peeling off.

### SUMMARY

A tire according to at least one aspect of the present disclosure can include a pair of beads, a carcass extending on and between the pair of beads, a tread located radially outward of the carcass, and a belt located between the tread and the carcass. The tread can include a base layer and a cap layer covering the entire base layer. The cap layer can be harder than the base layer. A loss tangent at 70° C. of the base layer can be lower than a loss tangent at 30° C. of the cap layer. Each end of the base layer can be located axially inward of an end of the belt. The belt can include an inner belt ply and an outer belt ply located radially outward of the inner belt ply. Each end of the outer belt ply can be located axially inward of an end of the inner belt ply. The tread can have a tread pattern including a plurality of circumferential grooves, thereby forming a plurality of land portions aligned in an axial direction in the tread. The plurality of land portions can include, in a portion between an equator plane of the tire and an end of the tread, a crown land portion located on the equator plane side, a shoulder land portion located on the tread end side, and a middle land portion located between the crown land portion and the shoulder land portion. A proportion ARc of the cap layer occupying the crown land portion can be represented as an average value of a ratio of a cap layer thickness to a base layer thickness in the crown land portion, a proportion ARm of the cap layer occupying the middle land portion can be represented as an average value of a ratio of a cap layer thickness to a base layer thickness in the middle land portion, and a proportion ARs of the cap layer occupying the shoulder land portion can be represented as an average value of a ratio of a cap layer thickness to a base layer thickness in the shoulder land portion. The cap layer proportion ARc of the crown land portion can be not less than 1.5 and not greater than 3.5. The cap layer proportion ARm of the middle land portion can be equal to or higher than the cap layer proportion ARc of the crown land portion. The cap layer proportion ARs of the shoulder land portion can be higher than the cap layer proportion ARm of the middle land portion and not less than 5.0 and not greater than 9.5.

### BRIEF DESCRIPTION OF THE DRAWINGS

FIG. 1 is a cross-sectional view showing a part of a tire according to one or more embodiments of the present disclosure;

FIG. 2 is a development view showing a tread pattern according to one or more embodiments of the present disclosure;

FIG. 3 is a schematic diagram showing a ground-contact surface shape of the tire according to one or more embodiments of the present disclosure;

FIG. 4 is an enlarged cross-sectional view showing a part of the tire according to one or more embodiments of the present disclosure;

FIG. 5 is an enlarged cross-sectional view showing a part of the tire according to one or more embodiments of the present disclosure;

FIG. 6 is an enlarged cross-sectional view showing a part of the tire according to one or more embodiments of the present disclosure;

FIG. 7 is a development view showing a modification of the tread pattern according to one or more embodiments of the present disclosure;

FIG. 8 is an enlarged cross-sectional view showing a shoulder portion of a conventional tire; and

FIG. 9 is an enlarged cross-sectional view showing a shoulder portion of another conventional tire.

### DETAILED DESCRIPTION

An object of one or more embodiments of the present disclosure, among one or more objects, can be to provide a tire that can suppress occurrence of tread peeling while suppressing an increase in rolling resistance.

Thus, according to one or more embodiments of the present disclosure, a tire that can suppress occurrence of tread peeling while suppressing an increase in rolling resistance, can be obtained, implemented, or provided.

A tire according to one or more embodiments of the present disclosure can be fitted on a rim. The interior of the tire can be filled with air to adjust the internal pressure of the tire. The tire fitted on the rim may also be referred to as tire-rim assembly. The tire-rim assembly can include the rim and the tire fitted on the rim.

In the present disclosure, a state where a tire is fitted on a standardized rim, the internal pressure of the tire is adjusted to a standardized internal pressure, and no load is applied to the tire can be regarded or referred to as standardized state.

A state where the tire is fitted on the standardized rim, the internal pressure of the tire is adjusted to 250 kPa, and no load is applied to the tire can be regarded or referred to as standard state.

In the present disclosure, unless otherwise specified, the dimensions and angles of each component of the tire are measured in the standardized state.

The dimensions and angles of each component in a meridian cross-section of the tire, which cannot be measured in a state where the tire is fitted on the standardized rim, can be measured in a cut plane of the tire obtained by cutting the tire along a plane including a rotation axis. In this measurement, the tire can be set such that the distance between right and left beads is equal to the distance between the beads in the tire that is fitted on the standardized rim. The configuration of the tire that cannot be confirmed in a state where the tire is fitted on the standardized rim can be confirmed in the above-described cut plane.

The standardized rim can mean a rim specified in a standard on which the tire is based. The “standard rim” in the JATMA standard, the “Design Rim” in the TRA standard, and the “Measuring Rim” in the ETRTO standard can be regarded as examples of standardized rims.

The standardized internal pressure can mean an internal pressure specified in the standard on which the tire is based. The “highest air pressure” in the JATMA standard, the “maximum value” recited in the “TIRE LOAD LIMITS AT VARIOUS COLD INFLATION PRESSURES” in the TRA standard, and the “INFLATION PRESSURE” in the ETRTO standard can be regarded as examples of standardized internal pressures.

A standardized load can mean a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard can be regarded as examples of standardized loads.

In the present disclosure, the “nominal cross-sectional width” can be regarded as the “nominal cross-sectional width” included in the “tire designation” specified in JIS D4202 “Automobile tyres-Designation and dimensions,” for instance.

In the present disclosure, a load index (LI) can be, for example, an index that is specified in the JATMA standard and that represents a maximum mass allowed to be applied to the tire under specified conditions, that is, a maximum load capacity, as an index number.

In the present disclosure, the hardness of a component formed from a crosslinked rubber, of the components included in the tire, can be measured, as an example, according to the standards of JIS K6253 under a temperature condition of 23° C. using a type A durometer.

In the present disclosure, a loss tangent (tan 8) of a component formed from a crosslinked rubber, of the components included in the tire, can be measured using a viscoelasticity spectrometer according to the standards of JIS K6394, as an example. The measurement conditions can be as follows:
Initial strain=10%
Dynamic strain=±1%
Frequency=10 Hz
Mode=stretch mode
Temperature=30° C. or 70° C.

In this measurement, a test piece (e.g., 40 mm long×4 mm wide×1 mm thick) can be sampled from the tire. The length direction of the test piece can be caused to coincide with the circumferential direction of the tire. When a test piece cannot be sampled from the tire, a test piece can be sampled, for instance, from a sheet-shaped crosslinked rubber (hereinafter, also referred to as rubber sheet) obtained by pressurizing and heating a rubber composition, which is used for forming the component to be measured, at a temperature of 170° C. for 12 minutes.

In the present disclosure, a tread portion of the tire can be regarded as a portion of the tire that comes into contact with a road surface. A bead portion can be regarded as a portion of the tire that is fitted to a rim. A sidewall portion can be a portion of the tire that extends between the tread portion and the bead portion. The tire can include a tread portion, a pair of bead portions, and a pair of sidewall portions as portions thereof.

A portion of the tread portion at each end thereof may also be referred to as shoulder portion. A portion of the tread portion at an equator plane, that is, a center portion thereof, may also be referred to as crown portion.

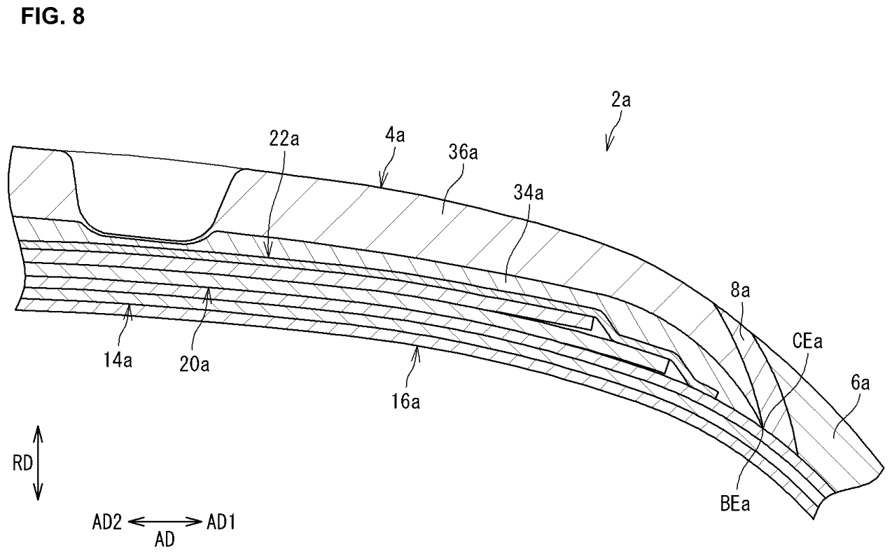

FIG. 8 shows a part of a conventional tire 2a. A tread 4a of the tire 2a includes a cap layer 36a and a base layer 34a. As shown in FIG. 8, an end BEa of the base layer 34a coincides with an end CEa of the cap layer 36a.

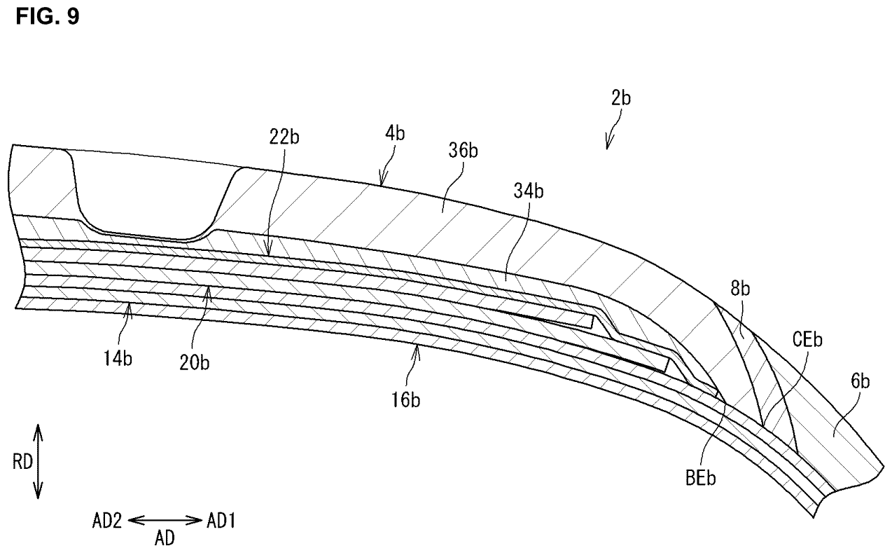

FIG. 9 shows a shoulder portion of another conventional tire 2b. In the tire 2b, an end BEb of a base layer 34b is located axially inward of an end CEb of a cap layer 36b. In the tire 2b, the cap layer 36b covering a portion of the base layer 34b at the end BEb is thicker than in the tire 2a shown in FIG. 8. In the shoulder portion, the base layer 34b of the tire 2b may be less likely to be exposed than the base layer 34a of the tire 2a shown in FIG. 8. A tread 4b of the tire 2b may be less likely to peel off than the tread 4a of the tire 2a.

Electric vehicles are becoming increasingly widespread due to environmental considerations. Electric vehicles are equipped with batteries. Batteries enabling travelling for a distance of around 500 km are heavy. Therefore, electric vehicles tend to be heavier than conventional gasoline-powered vehicles. Higher loads act on tires mounted on electric vehicles, than on tires mounted on gasoline-powered vehicles.

As described above, the tread 4b of the tire 2b shown in FIG. 9 may be less likely to peel off than the tread 4a of the tire 2a shown in FIG. 8. However, since electric vehicles are heavier than conventional gasoline-powered vehicles, the tread 4b may peel off even in the tire 2b for which a countermeasure for tread peeling has been taken.

Therefore, the present inventor has studied a technology capable of suppressing peeling of a tread while minimizing the influence on other performances (e.g., rolling resistance), in consideration of mounting to an electric vehicle.

### Outline of Exemplary Embodiments

One or more embodiments of the present disclosure can be directed to a tire including a pair of beads, a carcass extending on and between the pair of beads, a tread located radially outward of the carcass, and a belt located between the tread and the carcass, wherein
the tread includes a base layer and a cap layer covering the entire base layer,
the cap layer is harder than the base layer,
a loss tangent at 70° C. of the base layer is lower than a loss tangent at 30° C. of the cap layer,
each end of the base layer is located axially inward of an end of the belt,
the belt includes an inner belt ply and an outer belt ply located radially outward of the inner belt ply,
each end of the outer belt ply is located axially inward of an end of the inner belt ply
the tread has a tread pattern including a plurality of circumferential grooves, thereby forming a plurality of land portions aligned in an axial direction in the tread,
the plurality of land portions include, in a portion between an equator plane of the tire and an end of the tread, a crown land portion located on the equator plane side, a shoulder land portion located on the tread end side, and a middle land portion located between the crown land portion and the shoulder land portion,
a proportion ARc of the cap layer occupying the crown land portion is represented as an average value of a ratio of a cap layer thickness to a base layer thickness in the crown land portion,
a proportion ARm of the cap layer occupying the middle land portion is represented as an average value of a ratio of a cap layer thickness to a base layer thickness in the middle land portion,
a proportion ARs of the cap layer occupying the shoulder land portion is represented as an average value of a ratio of a cap layer thickness to a base layer thickness in the shoulder land portion,
the cap layer proportion ARc of the crown land portion is not less than 1.5 and not greater than 3.5,
the cap layer proportion ARm of the middle land portion is equal to or higher than the cap layer proportion ARc of the crown land portion, and
the cap layer proportion ARs of the shoulder land portion is higher than the cap layer proportion ARm of the middle land portion and not less than 5.0 and not greater than 9.5.

The tire of one or more embodiments of the present disclosure, such as set forth above, can suppress occurrence of tread peeling while suppressing an increase in rolling resistance.

In the tire, each end of the base layer can be located axially inward of the end of the belt. In the tire, the cap layer covering a portion of the base layer at the end thereof can be thicker than in the conventional tires. In each shoulder portion, the base layer can be less likely to be exposed. During limit running in which a relatively large load acts on the shoulder portion, the tread can be less likely to peel off.

In the tire according to one or more embodiments of the present disclosure, the proportion of the base layer occupying the shoulder land portion can be relatively low. The cap layer can be harder than the base layer. Therefore, there may be a concern that rolling resistance may increase, ride comfort may decrease, and road noise may increase, which can decrease quietness.

However, in the tire according to one or more embodiments of the present disclosure, the cap layer proportion ARc of the crown land portion can be not less than 1.5 and not greater than 3.5, the cap layer proportion ARm of the middle land portion can be equal to or higher than the cap layer proportion ARc of the crown land portion, and the cap layer proportion ARs of the shoulder land portion can be higher than the cap layer proportion ARm of the middle land portion and not less than 5.0 and not greater than 9.5, as example ranges. In other words, the proportion of the base layer occupying the land portion can be lower in the shoulder land portion and higher in the crown land portion and the middle land portion. The base layer can be softer and less likely to generate heat than the cap layer. The crown land portion and the middle land portion having a higher base layer proportion can contribute to suppressing one or more of an increase in rolling resistance, a decrease in ride comfort, and a decrease in quietness.

The tire according to one or more embodiments of the present disclosure can suppress occurrence of tread peeling while suppressing one or more of an increase in rolling resistance, a decrease in ride comfort, and a decrease in quietness.

According to one or more embodiments, a position of each end of the cap layer can coincide with a position of the end of the belt in the axial direction, or each end of the cap layer can be located axially outward of the end of the belt.

In this case, each end of the base layer can be covered with the cap layer having a sufficient thickness. In each shoulder portion, the base layer can be less likely to be exposed. During limit running in which a relatively large load acts on the shoulder portion, the tread can be less likely to peel off. The tire, thus, according to one or more embodiments, can effectively suppress occurrence of tread peeling.

According to one or more embodiments, a ground-contact surface obtained when the tire is fitted onto a standardized rim, an internal pressure of the tire is adjusted to 250 kPa, a camber angle of the tire is set to 0 degrees, a vertical load is applied to the tire, and the tire is brought into contact with a road surface composed of a flat surface, is a standard ground-contact surface,
the vertical load applied to the tire can be not less than 60% and not greater than 80% of a load indicated by a load index of the tire,
a ground-contact width of the standard ground-contact surface can be not less than 70% and not greater than 80% of a nominal cross-sectional width of the tire, and
a ratio of a sum of groove widths of the plurality of circumferential grooves included in the standard ground-contact surface to the ground-contact width of the standard ground-contact surface can be not less than 20% and not greater than 30%.

In this case, responsiveness, ride comfort, and quietness can be regarded as being well balanced. The tire can suppress occurrence of tread peeling while suppressing each of an increase in rolling resistance, a decrease in responsiveness, a decrease in ride comfort, and a decrease in quietness.

According to one or more embodiments, the tread pattern can include the four circumferential grooves, thereby forming the five land portions in the tread,
the five land portions can be the crown land portion located on the equator plane, a pair of the middle land portions located axially outward of the crown land portion, and a pair of the shoulder land portions located axially outward of the respective middle land portions, and
a ratio of a width of the crown land portion to the ground-contact width of the standard ground-contact surface can be not less than 14% and not greater than 16%.

In this case, the crown land portion having an appropriate width can be formed. In a four-wheeled vehicle (e.g., passenger car) on which the tire is mounted, a higher cornering force can be generated at each front tire than at the conventional tires. The tire can effectively suppress an increase in rolling resistance and occurrence of tread peeling while suppressing a decrease in responsiveness.

According to one or more embodiments, of the two ends of the tread, one end located on an inner side in a width direction of a vehicle when the tire is mounted on the vehicle can be regarded as a first reference end, and another end can be regarded as a second reference end,
a width of the shoulder land portion on the first reference end side can be not less than 90% and not greater than 100% of the width of the crown land portion,
a width of the middle land portion on the first reference end side can be not less than 90% and not greater than 100% of the width of the crown land portion,
a width of the middle land portion on the second reference end side can be not less than 97% and not greater than 107% of the width of the crown land portion, and
a width of the shoulder land portion on the second reference end side can be not less than 114% and not greater than 124% of the width of the crown land portion.

In this case, the ratio of a cornering force at each rear tire to a cornering force at each front tire can be effectively increased compared to the conventional tires. The tire can effectively suppress an increase in rolling resistance and occurrence of tread peeling while improving linearity.

According to one or more embodiments, the first reference end side of the crown land portion with respect to the equator plane can be regarded as a first portion, and the second reference end side of the crown land portion with respect to the equator plane can be regarded as a second portion, and
a ratio of a width of the second portion to the width of the crown land portion can be not less than 51% and not greater than 55%.

In this case, compared to the conventional tires, the tire can effectively increase the ratio of a cornering force at each rear tire to a cornering force at each front tire while effectively increasing the cornering force generated at each front tire. The tire can effectively suppress an increase in rolling resistance and occurrence of tread peeling while improving responsiveness and linearity.

### Details of Exemplary Embodiments

Hereinafter, one or more embodiments of the present disclosure will be described in detail with appropriate reference to the drawings.

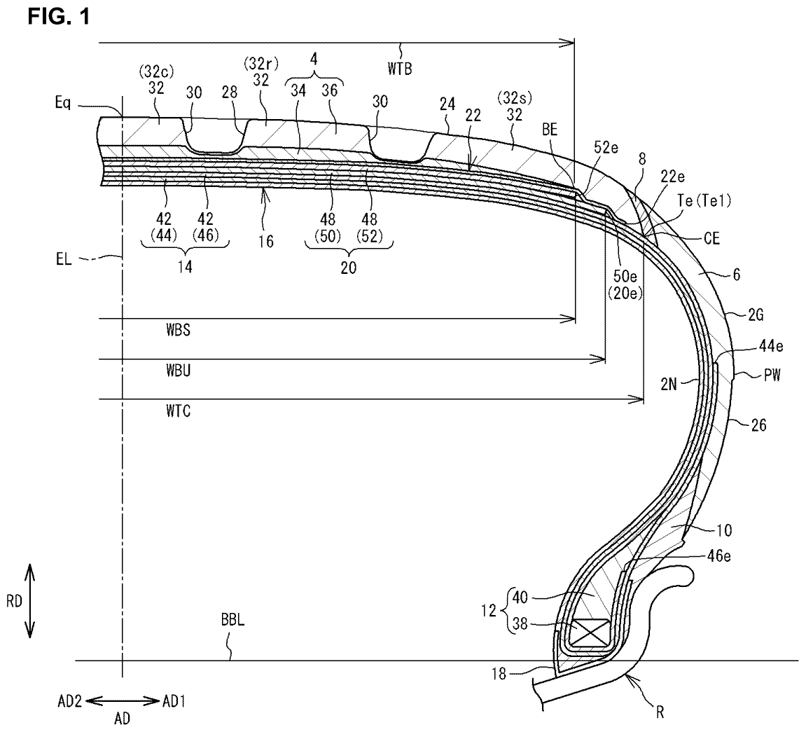

FIG. 1 shows a part of a tire 2 according to one or more embodiments of the present disclosure. The tire 2 can be a pneumatic tire for a passenger car. The tire 2 in FIG. 1 can be regarded as new. A tread 4 may not be worn.

FIG. 1 shows a part of a cross-section, of the tire 2, along a plane including the rotation axis of the tire 2. The cross-section shown in FIG. 1 may also be referred to as meridian cross-section. A direction indicated by a double-headed arrow AD is the axial direction of the tire 2. The axial direction of the tire 2 can mean a direction parallel to the rotation axis of the tire 2. A direction indicated by a double-headed arrow RD is the radial direction of the tire 2. A direction perpendicular to the drawing sheet of FIG. 1 is the circumferential direction of the tire 2.

In FIG. 1, an alternate long and short dash line EL extending in the radial direction can represent the equator plane of the tire 2.

In FIG. 1, the tire 2 is fitted on a rim R. The space between the tire 2 and the rim R can be filled with air, for example, to adjust the internal pressure of the tire 2. The rim R can be a standardized rim.

In FIG. 1, a solid line BBL extending in the axial direction can be a bead base line. This bead base line BBL can be a line that defines the rim diameter (see, e.g., JATMA or the like) of the rim R.

In FIG. 1, a position indicated by reference character Eq can represent the point of intersection of an outer surface 2G of the tire 2 (specifically, a tread surface described later) and the equator plane EL. The point of intersection Eq can be the equator of the tire 2.

In the case where a groove is located on the equator plane EL, the equator Eq can be specified on the basis of a virtual outer surface obtained on the assumption that irregularities such as grooves are not provided thereon. The equator Eq can be a radially outer end of the tire 2.

In FIG. 1, a position indicated by reference character PW is an axially outer end (hereinafter referred to as outer end PW) of the tire 2. In the case where decorations such as patterns and letters are present on the outer surface 2G, the outer end PW can be specified on the basis of a virtual outer surface obtained on the assumption that the decorations are not present thereon. The distance in the axial direction from one outer end PW to the other outer end PW, which can be specified in the tire 2 in the standardized state, can be the cross-sectional width (see, e.g., JATMA or the like) of the tire 2.

In the present disclosure, the “nominal cross-sectional width” can be used, and this “nominal cross-sectional width” can mean the “nominal cross-sectional width” included in the “tire designation,” for instance, as specified in JIS D4202 “Automobile tyres-Designation and dimensions.” For example, if tire size indicated in the “tire designation” of the tire 2 is 245/50R19, the nominal cross-sectional width of the tire 2 can be 245 mm.

The nominal cross-sectional width of the tire (i.e., the tire 2) to which one or more embodiments of the present disclosure can be applied is not less than 215 mm and not greater than 325 mm, as an example range. The load index (LI) of the tire 2 can be not less than 90.

The tire 2 can include the tread 4, a pair of sidewalls 6, a pair of wings 8, a pair of clinches 10, a pair of beads 12, a carcass 14, an inner liner 16, a pair of chafers 18, a belt 20, and a band 22.

The tread 4 can be located radially outward of the carcass 14. The tread 4 can be formed from a crosslinked rubber. In FIG. 1, a position indicated by reference character Te can be an end of the tread 4.

According to one or more embodiments of the present disclosure, of two ends Te of the tread 4, one end Te located on the inner side in the width direction of a vehicle when the tire 2 is mounted on the vehicle can be regarded as a first reference end Te1, and the other end Te can be regarded as a second reference end Te2. In FIG. 1, the end Te of the tread 4 located on an arrow AD1 side can be regarded as the first reference end Te1, and can be located on the inner side in the width direction of the vehicle when the tire 2 is mounted on the vehicle. The end Te of the tread 4 located on an arrow AD2 side can be regarded as the second reference end Te2, and can be located on the outer side in the width direction of the vehicle when the tire 2 is mounted on the vehicle.

The tread 4 can come into contact with a road surface at a tread surface 24 thereof. The tread 4 can have the tread surface 24.

A side surface 26 can be connected to the tread surface 24. The outer surface 2G of the tire 2 can includes the tread surface 24 and a pair of such side surfaces 26. The tread surface 24 can include the equator Eq, and each side surface 26 can include a maximum width position PW.

The contour of the tread surface 24 in the meridian cross-section can be represented as the contour of a virtual tread surface obtained on the assumption that irregularities such as grooves are not provided thereon. The contour of the tread surface 24, that is, the contour of the virtual tread surface, can include a plurality of arcs and can be formed by combining these arcs such that adjacent arcs are tangent to each other.

Among the plurality of arcs forming the contour of the tread surface 24, the arc located on each outermost side in the axial direction can have the smallest radius. The side surface 26 can be connected to this arc having the smallest radius.

Grooves 28 can be formed on the tread 4. Accordingly, a tread pattern can be formed.

The tread pattern can include a plurality of circumferential grooves 30 extending continuously in the circumferential direction. Accordingly, a plurality of land portions 32 aligned in the axial direction can be formed in the tread 4. The land surfaces of the land portions 32 can be included in the tread surface 24.

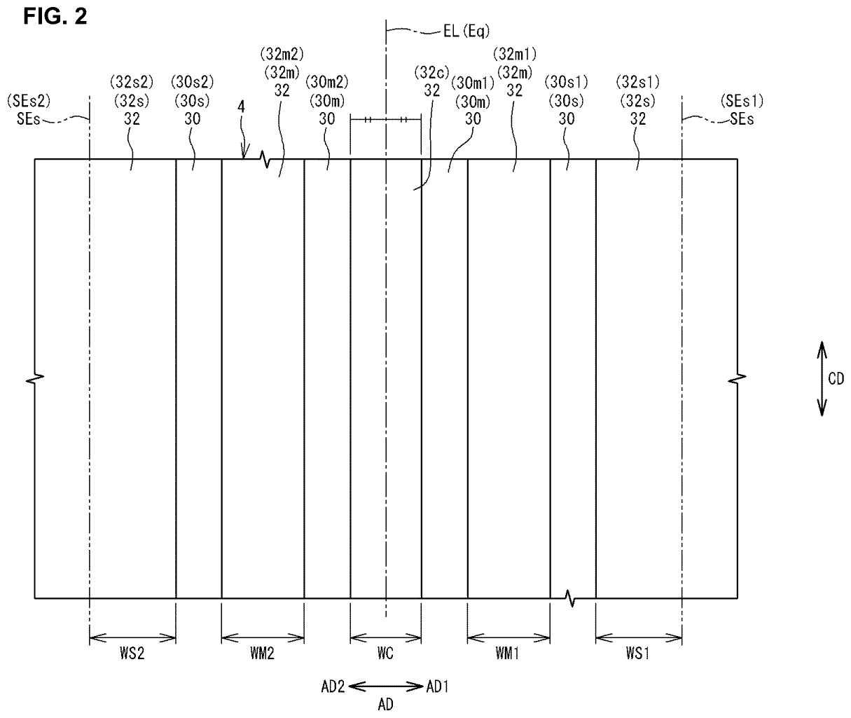

FIG. 2 is a development view showing a part of the tread surface 24 according to one or more embodiments of the present disclosure. A direction indicated by a double-headed arrow AD is the axial direction of the tire 2. A direction indicated by a double-headed arrow CD is the circumferential direction of the tire 2. In FIG. 2, a direction indicated by an arrow AD1 corresponds to the first reference end Te1 side, and a direction indicated by an arrow AD2 corresponds to the second reference end Te2 side.

The tread 4 of the tire 2, according to embodiments of the present disclosure, is not limited to a tread 4 on which only the circumferential grooves 30 are formed. On the tread 4, lateral grooves extending substantially in the axial direction or sipes may be formed.

The tread pattern of the tire 2 can include four circumferential grooves 30 aligned in the axial direction. The groove depth of each circumferential groove 30 can be not less than 5.0 mm and not greater than 7.5 mm, as an example range. The groove width of each circumferential groove 30 can be not less than 5.0 mm and not greater than 20.0 mm, as an example range.

Among the four circumferential grooves 30, two circumferential grooves 30 each located on the outermost side in the axial direction can be shoulder circumferential grooves 30s. Two circumferential grooves 30 located axially inward of the shoulder circumferential grooves 30s can be middle circumferential grooves 30m. The tread pattern of the tire 2 can include the pair of shoulder circumferential grooves 30s, and the pair of middle circumferential grooves 30m located between the pair of shoulder circumferential grooves 30s. In the tire 2, at least one circumferential groove may be provided between the pair of middle circumferential grooves 30m.

In the tire 2, of the two middle circumferential grooves 30m, the middle circumferential groove 30m located on the first reference end Te1 side can be a first middle circumferential groove 30m1, and the middle circumferential groove 30m located on the second reference end Te2 side can be a second middle circumferential groove 30m2.

Of the two shoulder circumferential grooves 30s, the shoulder circumferential groove 30s located on the first reference end Te1 side can be a first shoulder circumferential groove 30s1, and the shoulder circumferential groove 30s located on the second reference end Te2 side can be a second shoulder circumferential groove 30s2.

As described above, the tread pattern of the tire 2 can include the four circumferential grooves 30 aligned in the axial direction. Accordingly, five land portions 32 extending in the circumferential direction can be formed. The edges of the circumferential grooves 30 can also be the edges of the land portions 32.

Among the five land portions 32 aligned in the axial direction, two land portions 32 each located on the outermost side can be shoulder land portions 32s. Each shoulder land portion 32s can include a ground-contact end SEs of a standard ground-contact surface described later. Two land portions 32 located axially inward of the shoulder land portions 32s can be middle land portions 32m. A land portion 32 located between the two middle land portions 32m can be a crown land portion 32c. The crown land portion 32c of the tire 2 can include the equator Eq.

In the tread pattern, the four circumferential grooves 30 can be arranged symmetrically with respect to the equator plane EL. Therefore, the five land portions 32 can also be arranged symmetrically with respect to the equator plane EL.

The five land portions 32 formed in the tread 4 can be the crown land portion 32c located on the equator plane EL, the pair of middle land portions 32m located axially outward of the crown land portion 32c, and the pair of shoulder land portions 32s located axially outward of the respective middle land portions 32m.

As shown in FIG. 1, in the tire 2, the plurality of land portions 32 can include, in a portion between the equator plane EL and each end Te of the tread 4, the crown land portion 32c located on the equator plane EL side, the shoulder land portion 32s located on the end Te side of the tread 4, and the middle land portion 32m located between the crown land portion 32c and the shoulder land portion 32s.

According to one or more embodiments, one circumferential groove 30 may be further provided between the pair of middle circumferential grooves 30m, and two crown land portions 32c may be formed. In this case, the circumferential groove 30 located between the two crown land portions 32c may also be referred to as crown circumferential groove. In this case as well, the plurality of land portions 32 formed in the tread 4 can include, in the portion between the equator plane EL and each end Te of the tread 4, the crown land portion 32c located on the equator plane EL side, the shoulder land portion 32s located on the end Te side of the tread 4, and the middle land portion 32m located between the crown land portion 32c and the shoulder land portion 32s. The crown land portion 32c may not include the equator Eq, but the crown circumferential groove can be located on the equator plane EL.

In the tire 2, of the two middle land portions 32m, the middle land portion 32m located on the first reference end Te1 side can be a first middle land portion 32m1, and the middle land portion 32m located on the second reference end Te2 side can be a second middle land portion 32m2.

Of the two shoulder land portions 32s, the shoulder land portion 32s located on the first reference end Te1 side can be a first shoulder land portion 32s1, and the shoulder land portion 32s located on the second reference end Te2 side can be a second shoulder land portion 32s2.

The width of each land portion 32 formed in the tread 4 can be represented as the distance in the axial direction from one edge to the other edge of the land portion 32, except for the shoulder land portions 32s. The width of each shoulder land portion 32s can be represented as the distance in the axial direction from the edge on the equator plane EL side of the shoulder land portion 32s to the ground-contact end SEs of the standard ground-contact surface.

In the case where each edge of each land portion 32 is formed by chamfering such as rounding, the width of the land portion 32 can be represented with the point of intersection of an extension line of the land surface of the land portion 32 and an extension line of each wall surface of the land portion 32 as each edge of the land portion 32. The extension line of the land surface can be the contour of the tread surface 24. The extension line of each wall surface can be represented as a tangent line of the wall surface with the boundary between the wall surface and the chamfered portion as a tangent point.

In FIG. 2, a length indicated by a double-headed arrow WC can indicate the width of the crown land portion 32c. In the tire 2, the equator plane EL can intersect the crown land portion 32c at the center of the width WC of the crown land portion 32c.

In FIG. 2, a length indicated by a double-headed arrow WM1 can indicate the width of the first middle land portion 32m1. A length indicated by a double-headed arrow WM2 can indicate the width of the second middle land portion 32m2. In the tire 2, the width WM1 of the first middle land portion 32m1 can be equal to the width WM2 of the second middle land portion 32m2.

In FIG. 2, a length indicated by a double-headed arrow WS1 can indicate the width of the first shoulder land portion 32s1. A length indicated by a double-headed arrow WS2 can indicate the width of the second shoulder land portion 32s2. In the tire 2, the width WS1 of the first shoulder land portion 32s1 can be equal to the width WS2 of the second shoulder land portion 32s2.

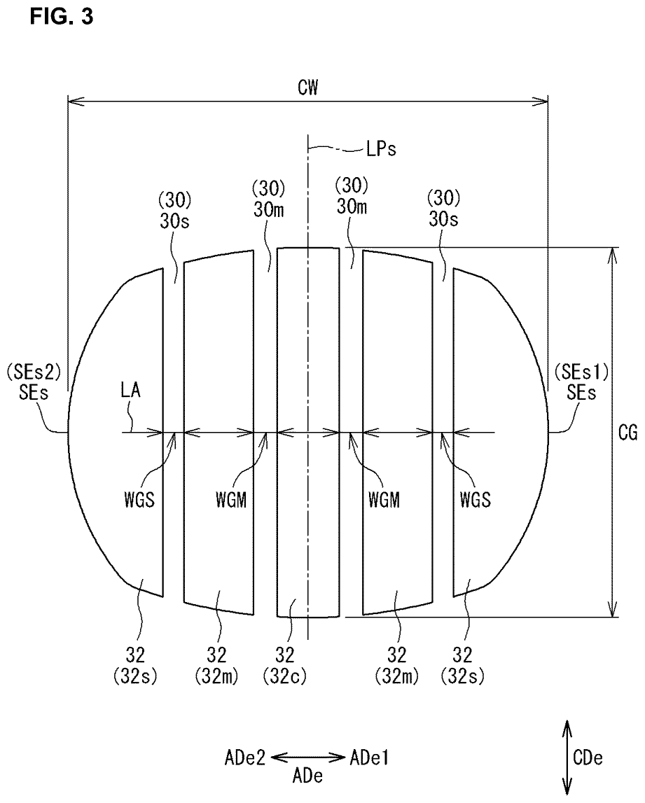

FIG. 3 schematically shows a ground-contact surface shape of the tire 2 according to one or more embodiments of the present disclosure. In FIG. 3, a direction indicated by a double-headed arrow ADe can correspond to the axial direction of the tire 2. A direction indicated by a double-headed arrow CDe can correspond to the circumferential direction of the tire 2. In FIG. 3, a direction indicated by an arrow ADe1 can correspond to the first reference end Te1 side, and a direction indicated by an arrow ADe2 can correspond to the second reference end Te2 side.

A ground-contact surface can be obtained, for example, using a ground-contact surface shape measuring device. The ground-contact surface can be obtained when the tire 2 is fitted onto the rim R, the internal pressure of the tire 2 is adjusted, a vertical load is applied to the tire 2, and the tire 2 is brought into contact with a road surface composed of a flat surface in this device. To obtain the ground-contact surface, the tire 2 can be placed such that the rotation axis thereof is parallel to the road surface. The above-described vertical load can be applied to the tire 2 in a direction perpendicular to the road surface. In other words, the vertical load can be applied to the tire 2 in a state where the camber angle of the tire 2 is set to 0°.

An image of the ground-contact surface formed when the tire 2 comes into contact with the flat surface can be obtained. The contour of the ground-contact surface can be specified on the basis of the obtained image.

The contour of the ground-contact surface, that is, the ground-contact surface shape of the ground-contact surface, can be obtained by tracing the perimeter of the ground-contact surface in the image of the ground-contact surface.

According to one or more embodiments of the present disclosure, a ground-contact surface obtained when the tire 2 is fitted onto the standardized rim, the internal pressure of the tire 2 is adjusted to 250 kPa, the camber angle of the tire 2 is set to 0 degrees, a vertical load is applied to the tire 2, and the tire 2 is brought into contact with a road surface composed of a flat surface, can be the standard ground-contact surface. The vertical load applied to the tire 2 to obtain the standard ground-contact surface can be, for instance, not less than 60% and not greater than 80% of a load indicated by the load index of the tire 2.

In FIG. 3, a position indicated by each reference character SEs can indicate a ground-contact end of the standard ground-contact surface. Of the two ground-contact ends SEs, the ground-contact end SEs located on the arrow ADe1 side can be a first ground-contact end SEs1, and the ground-contact end SEs located on the arrow ADe2 side can be a second ground-contact end SEs2. The first ground-contact end SEs1 side can correspond to the above-described first reference end Te1 side, and the second ground-contact end SEs2 side can correspond to the above-described second reference end Te2 side.

As shown in FIG. 3, the standard ground-contact surface can include a ground-contact surface corresponding to each land portion 32, specifically, ground-contact surfaces of the crown land portion 32c, the two middle land portions 32m, and the two shoulder land portions 32s. The space between the ground-contact surfaces corresponding to adjacent two land portions 32 can correspond to the circumferential groove 30. Therefore, the standard ground-contact surface can include the plurality of circumferential grooves 30, specifically, the two middle circumferential grooves 30m and the two shoulder circumferential grooves 30s.

The tread 4 can include a base layer 34 and a cap layer 36. The tread 4 of the tire 2 can be composed of the base layer 34 and the cap layer 36 aligned in the radial direction. Optionally, the tread 4 can consist of the base layer 34 and the cap layer 36.

As shown in FIG. 1, for instance, the base layer 34 can be stacked on the band 22. The entire base layer 34 can be covered with the cap layer 36. The base layer 34 can be formed from a crosslinked rubber that has low heat generation properties.

The cap layer 36 can be located radially outward of the base layer 34. The cap layer 36 can include the above-described tread surface 24. The cap layer 36 can come into contact with a road surface. The cap layer 36 can be formed from a crosslinked rubber for which wear resistance and grip performance are taken into consideration.

In FIG. 1, a position indicated by reference character BE can indicate an end of the base layer 34. A length indicated by a double-headed arrow WTB can be the width of the base layer 34. The width WTB of the base layer 34 can be the distance in the axial direction from one end BE to another end BE of the base layer 34. A position indicated by reference character CE can indicate an end of the cap layer 36. A length indicated by a double-headed arrow WTC can be the width of the cap layer 36. The width WTC of the cap layer 36 can be the distance in the axial direction from one end CE to another end CE of the cap layer 36.

In the tire 2, each end CE of the cap layer 36 can be located axially outward of the end BE of the base layer 34. The width WTC of the cap layer 36 can be wider than the width WTB of the base layer 34.

Each end CE of the cap layer 36 can be the end Te of the tread 4. The width of the tread 4 can be represented as the width WTC of the cap layer 36.

In the tire 2, the cap layer 36 can be harder than the base layer 34. Specifically for instance, the hardness of the cap layer 36 can be not less than 60 and not greater than 70, and the hardness of the base layer 34 can be not less than 50 and not greater than 65. The difference between the hardness of the cap layer 36 and the hardness of the base layer 34 is not less than 10 and not greater than 20, for instance.

The temperature at which the loss tangent of the base layer 34 is measured can be 70° C., as an example. The loss tangent at 70° C. of the base layer 34 can be not less than 0.02 and not greater than 0.10, as an example.

The temperature at which the loss tangent of the cap layer 36 is measured can be 30° C. The loss tangent at 30° C. of the cap layer 36 can be not less than 0.12 and not greater than 0.40, as an example.

The loss tangent at 70° C. of the base layer 34 can be lower than the loss tangent at the 30° C. of the cap layer 36. The ratio of the loss tangent at 30° C. of the base layer 34 to the loss tangent at 70° C. of the cap layer 36 can be not less than 0.10 and not greater than 0.38, for instance.

Each sidewall 6 can be located radially inward of the tread 4. The sidewall 6 can be located axially outward of the carcass 14. The sidewall 6 can includes the above-described maximum width position PW. The sidewall 6 can formed from a crosslinked rubber for which cut resistance is taken into consideration.

Each wing 8 can be located between the tread 4 and the sidewall 6. The tread 4 and the sidewall 6 can be joined via the wing 8. The wing 8 can be formed from a crosslinked rubber for which adhesiveness is taken into consideration.

Each clinch 10 can be located radially inward of the sidewall 6. The clinch 10 can come into contact with the rim R. The clinch 10 can be formed from a crosslinked rubber, for instance, for which wear resistance is taken into consideration.

Each bead 12 can be located radially inward of the sidewall 6. The bead 12 can be located axially inward of the clinch 10.

The bead 12 can include a core 38 and an apex 40. The core 38 can extend in the circumferential direction. The core 38 can include a steel wire, as an example. The apex 40 can be located radially outward of the core 38. The apex 40 can be tapered outward. The apex 40 can be formed from a crosslinked rubber that has relatively high stiffness.

The carcass 14 can be located inward of the tread 4, the pair of sidewalls 6, and the pair of clinches 10. The carcass 14 can extend on and between the pair of beads 12.

The carcass 14 can include at least one carcass ply 42. The carcass 14 of the tire 2 can be composed of two carcass plies 42. On the radially inner side of the tread 4, the carcass ply 42 located on an inner surface 2N side of the tire 2 can be a first carcass ply 44, and the carcass ply 42 located outward of the first carcass ply 44 can be a second carcass ply 46.

As shown in FIG. 1, the two carcass plies 42 can be turned up from the inner side to the outer side in the axial direction at the respective beads 12. Each end 44e of the first carcass ply 44 can be located radially outward of the maximum width position PW. Each end 46e of the second carcass ply 46 can be located between the apex 40 and the turned-up first carcass ply 44.

Each carcass ply 42 can include a relatively large number of carcass cords aligned with each other. These carcass cords can intersect the equator plane EL. The carcass 14 of the tire 2 can have a radial structure. In the tire 2, a cord formed from an organic fiber can be used as each carcass cord. Examples of the organic fiber can include nylon fibers, rayon fibers, polyester fibers, and aramid fibers.

The inner liner 16 can be located inward of the carcass 14. The inner liner 16 can form the inner surface 2N of the tire 2. The inner liner 16 can be formed from a crosslinked rubber, for instance, that has an excellent air blocking property. The inner liner 16 can maintain the internal pressure of the tire 2.

Each chafer 18 can be located radially inward of the bead 12. The chafer 18 can come into contact with the rim R. The chafer 18 of the tire 2 can include a fabric and a rubber with which the fabric is impregnated.

As shown in FIG. 1, the inner end of the chafer 18 can form a part of the tire inner surface 2N. The outer end of the chafer 18 can be located radially outward of the inner end thereof. The outer end of the chafer 18 can be located between the turned-up first carcass ply 44 and the clinch 10.

The belt 20 can be located between the tread 4 and the carcass 14 in the radial direction. The belt 20 can be stacked on the carcass 14.

The above-described equator plane EL can intersect the belt 20 at the center of the width of the belt 20. Both ends 20e of the belt 20 can be located so as to be opposed to each other across the equator plane EL.

The belt 20 can include a plurality of belt plies 48 aligned in the radial direction. Among the plurality of belt plies 48, the belt ply 48 located on the innermost side can be an inner belt ply 50, and the belt ply 48 located on the outermost side can be an outer belt ply 52. The belt 20 can include the inner belt ply 50 and the outer belt ply 52. The outer belt ply 52 can be located radially outward of the inner belt ply 50.

The belt 20 of the tire 2 can be composed or consist of two belt plies 48. Specifically, the belt 20 can be composed or consist of the inner belt ply 50 and the outer belt ply 52.

The inner belt ply 50 can be stacked on the carcass 14 on the radially inner side of the tread 4. The outer belt ply 52 can be stacked on the inner belt ply 50.

In FIG. 1, a double-headed arrow WBU can indicate the width of the inner belt ply 50. The width WBU of the inner belt ply 50 can be the distance in the axial direction from one end 50e to another end 50e of the inner belt ply 50. A double-headed arrow WBS can indicate the width of the outer belt ply 52. The width WBS of the outer belt ply 52 can be the distance in the axial direction from one end 52e to another end 52e of the outer belt ply 52.

Each of the plurality of belt plies 48 included in the belt 20 can include a relatively large number of belt cords aligned with each other. The belt cords can be steel cords, according to one or more embodiments of the present disclosure.

Each belt cord can be inclined with respect to the equator plane EL. The direction of inclination of the belt cords included in the outer belt ply 52 can be opposite to the direction of inclination of the belt cords included in the inner belt ply 50.

As shown in FIG. 1, each end 52e of the outer belt ply 52 can be located axially inward of the end 50e of the inner belt ply 50. The length from the end 52e of the outer belt ply 52 to the end 50e of the inner belt ply 50 can be not less than 3 mm and not greater than 10 mm, as an example range.

The width WBS of the outer belt ply 52 can be narrower than the width WBU of the inner belt ply 50. In other words, the inner belt ply 50 can be the belt ply 48 having the widest width among the belt plies 48 included in the belt 20. The width of the belt 20 can be represented as the width WBU of the wide inner belt ply 50. Each end 50e of the inner belt ply 50 can be the end 20e of the belt 20.

In the tire 2, the width WBU of the inner belt ply 50, that is, the width WBU of the belt 20, can be not less than 40% and not greater than 65% of the nominal cross-sectional width of the tire 2, for instance.

The band 22 can be located between the tread 4 and the belt 20 in the radial direction. Each end 22e of the band 22 can be located axially inward of the end Te of the tread 4. The entire band 22 can be covered with the tread 4.

The band 22 can be stacked on the belt 20. Each end 22e of the band 22 can be located axially outward of the end 20e of the belt 20. The length from the end 20e of the belt 20 to the end 22e of the band 22 can be not less than 3 mm and not greater than 7 mm, for instance.

The above-described equator plane EL can intersect the band 22 at the center of the width of the band 22. Both ends 22e of the band 22 can be located so as to be opposed to each other across the equator plane EL. The band 22 can be a full band, according to one or more embodiments of the present disclosure. The band 22 may be composed or consist of a pair of edge bands that are placed so as to be spaced apart from each other in the axial direction with the equator plane EL interposed therebetween and can each be formed so as to cover a portion of the belt 20 at the end 20e. The band 22 may be composed or consist of a full band and a pair of edge bands.

The band 22 can include a helically wound band cord. In the band 22, the band cord can extend substantially in the circumferential direction. Specifically, an angle of the band cord with respect to the circumferential direction can be not greater than 5°. The band 22 can have a jointless structure. A cord formed from an organic fiber can be used as the band cord. Examples of the organic fiber can include nylon fibers, rayon fibers, polyester fibers, and aramid fibers.

As shown in FIG. 1, the base layer 34 and the cap layer 36 included in the tread 4 can extend in a layer shape along the tread surface 24 in the meridian cross-section.

In the tire 2, the thickness of each layer included in the tread 4 can be represented as a length along a normal line of the outer surface 2G of the tire 2 (specifically, the tread surface 24) in the meridian cross-section of the tire 2. This normal line can be specified on the basis of the contour of the tread surface 24 and may also be referred to as thickness reference line.

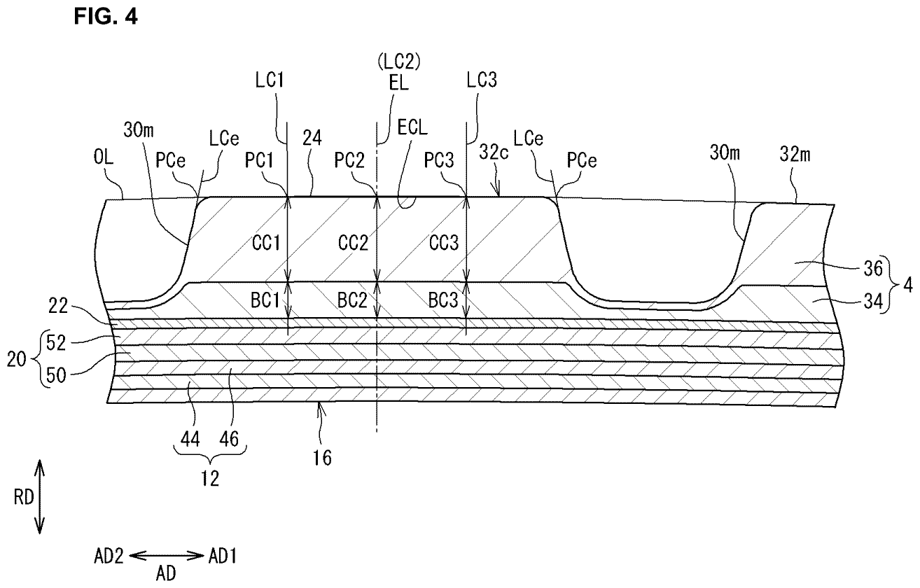

FIG. 4 shows a part of the tire 2 shown in FIG. 1. FIG. 4 shows a cross-section of the crown land portion 32c. A position indicated by each reference character PCe can indicate an edge of the crown land portion 32c. The edge PCe can be the point of intersection of an extension line of a land surface, that is, a contour OL of the tread surface 24, and an extension line LCe of a wall surface. A straight line ECL can be a line segment connecting the edge PCe on the first reference end Te1 side and the edge PCe on the second reference end Te2 side of the crown land portion 32c.

In FIG. 4, straight lines LC1, LC2, and LC3 can be thickness reference lines at the crown land portion 32c. Reference characters PC1, PC2, and PC3 can indicate positions that divide the line segment ECL, which connects the edge PCe on the first reference end Te1 side and the edge PCe on the second reference end Te2 side of the crown land portion 32c, into four equal parts. The thickness reference line LC1 can pass through the position PC1, the thickness reference line LC2 can pass through the position PC2, and the thickness reference line LC3 can pass through the position PC3. The thickness reference line LC2 of the tire 2 can coincide with the equator plane EL.

A length indicated by a double-headed arrow CC1 along the thickness reference line LC1 can be the thickness of the cap layer 36 at the position PC1. A length indicated by a double-headed arrow BC1 can be the thickness of the base layer 34 at the position PC1. A ratio CC1/BC1 of the thickness CC1 of the cap layer 36 to the thickness BC1 of the base layer 34 can be a cap layer thickness ratio ARc1 at the position PC1.

A length indicated by a double-headed arrow CC2 along the thickness reference line LC2 can be the thickness of the cap layer 36 at the position PC2. A length indicated by a double-headed arrow BC2 can be the thickness of the base layer 34 at the position PC2. A ratio CC2/BC2 of the thickness CC2 of the cap layer 36 to the thickness BC2 of the base layer 34 can be a cap layer thickness ratio ARc2 at the position PC2.

A length indicated by a double-headed arrow CC3 along the thickness reference line LC3 can be the thickness of the cap layer 36 at the position PC3. A length indicated by a double-headed arrow BC3 can be the thickness of the base layer 34 at the position PC3. A ratio CC3/BC3 of the thickness CC3 of the cap layer 36 to the thickness BC3 of the base layer 34 can be a cap layer thickness ratio ARc3 at the position PC3.

In the tire 2, a proportion ARc of the cap layer 36 occupying the crown land portion 32c can be represented as the average value of a ratio CC/BC of a cap layer thickness CC to a base layer thickness BC in the crown land portion 32c. Specifically, the cap layer proportion ARc can be represented as the average value of the cap layer thickness ratio CC1/BC1 at the position PC1, the cap layer thickness ratio CC2/BC2 at the position PC2, and the cap layer thickness ratio CC3/BC3 at the position PC3.

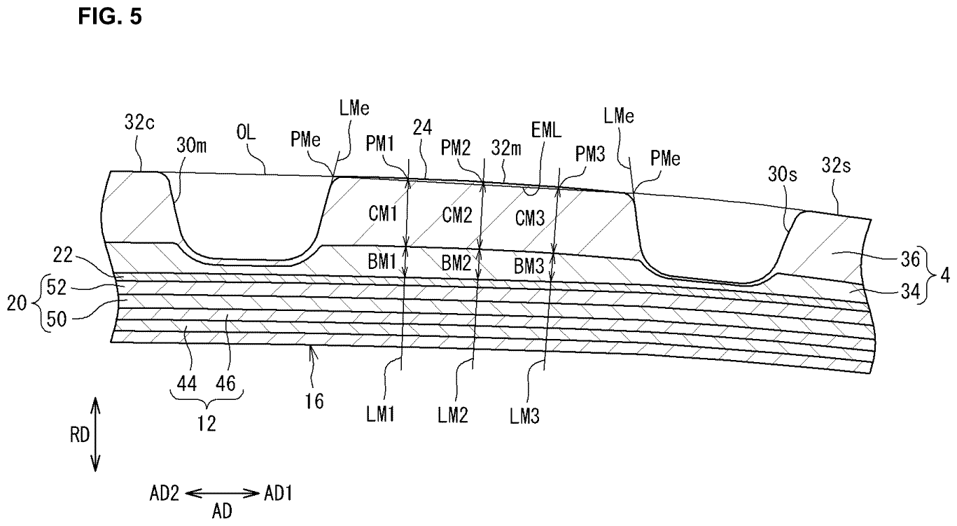

FIG. 5 shows a part of the tire 2 shown in FIG. 1. FIG. 5 shows a cross-section of the middle land portion 32m. A position indicated by each reference character PMe can indicate an edge of the middle land portion 32m. The edge PMe can be the point of intersection of an extension line of a land surface, that is, the contour OL of the tread surface 24, and an extension line LMe of a wall surface. A straight line EML can be a line segment connecting the edge PMe on the equator plane EL side of the middle land portion 32m and the edge PMe on the end Te side of the tread 4.

In FIG. 5, straight lines LM1, LM2, and LM3 can be thickness reference lines at the middle land portion 32m. Reference characters PM1, PM2, and PM3 can indicate positions that divide the line segment EML, which connects the edge PMe on the equator plane EL side of the middle land portion 32m and the edge PMe on the end Te side of the tread 4, into four equal parts. The thickness reference line LM1 can pass through the position PM1, the thickness reference line LM2 can pass through the position PM2, and the thickness reference line LM3 can pass through the position PM3.

A length indicated by a double-headed arrow CM1 along the thickness reference line LM1 can be the thickness of the cap layer 36 at the position PM1. A length indicated by a double-headed arrow BM1 can be the thickness of the base layer 34 at the position PM1. A ratio CM1/BM1 of the thickness CM1 of the cap layer 36 to the thickness BM1 of the base layer 34 can be a cap layer thickness ratio ARm1 at the position PM1.

A length indicated by a double-headed arrow CM2 along the thickness reference line LM2 can be the thickness of the cap layer 36 at the position PM2. A length indicated by a double-headed arrow BM2 can be the thickness of the base layer 34 at the position PM2. A ratio CM2/BM2 of the thickness CM2 of the cap layer 36 to the thickness BM2 of the base layer 34 can be a cap layer thickness ratio ARm2 at the position PM2.

A length indicated by a double-headed arrow CM3 along the thickness reference line LM3 can be the thickness of the cap layer 36 at the position PM3. A length indicated by a double-headed arrow BM3 can be the thickness of the base layer 34 at the position PM3. A ratio CM3/BM3 of the thickness CM3 of the cap layer 36 to the thickness BM3 of the base layer 34 can be a cap layer thickness ratio ARm3 at the position PM3.

In the tire 2, according to one or more embodiments of the present disclosure, a proportion ARm of the cap layer 36 occupying the middle land portion 32m can be represented as the average value of a ratio CM/BM of a cap layer thickness CM to a base layer thickness BM in the middle land portion 32m. Specifically, the cap layer proportion ARm can be represented as the average value of the cap layer thickness ratio CM1/BM1 at the position PM1, the cap layer thickness ratio CM2/BM2 at the position PM2, and the cap layer thickness ratio CM3/BM3 at the position PM3.

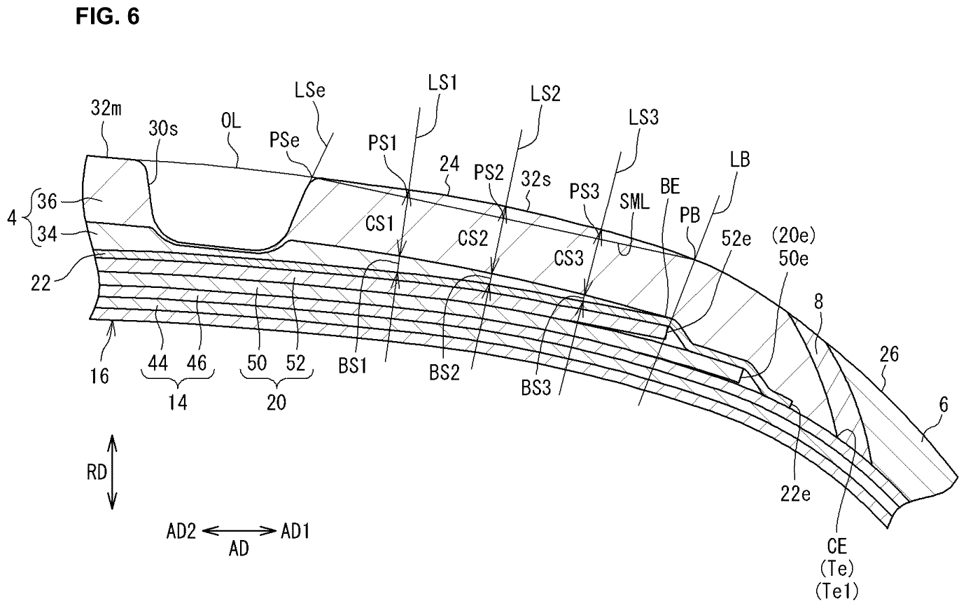

FIG. 6 shows a part of the tire 2 shown in FIG. 1. FIG. 6 shows a cross-section of the shoulder land portion 32s. A position indicated by reference character PSe can indicate an edge of the shoulder land portion 32s. The edge PSe can be the point of intersection of an extension line of a land surface, that is, the contour OL of the tread surface 24, and an extension line LSe of a wall surface. A straight line LB can be a normal line of the tread surface 24 that passes through the end 52e of the outer belt ply 52. A position indicated by reference character PB can be the point of intersection of the normal line LB and the tread surface 24. The point of intersection PB can be a reference position that defines the thicknesses of the cap layer 36 and the base layer 34 in the shoulder land portion 32s. A straight line SML can be a line segment connecting the edge PSe of the shoulder land portion 32s and the reference position PB.

In FIG. 6, straight lines LS1, LS2, and LS3 can be thickness reference lines at the shoulder land portion 32s. Reference characters PS1, PS2, and PS3 can indicate positions that divide the line segment SML, which connects the edge PSe of the shoulder land portion 32s and the reference position PB, into four equal parts. The thickness reference line LS1 can pass through the position PS1, the thickness reference line LS2 can pass through the position PS2, and the thickness reference line LS3 can pass through the position PS3.

A length indicated by a double-headed arrow CS1 along the thickness reference line LS1 can be the thickness of the cap layer 36 at the position PS1. A length indicated by a double-headed arrow BS1 can be the thickness of the base layer 34 at the position PS1. A ratio CS1/BS1 of the thickness CS1 of the cap layer 36 to the thickness BS1 of the base layer 34 can be a cap layer thickness ratio ARs1 at the position PS1.

A length indicated by a double-headed arrow CS2 along the thickness reference line LS2 can be the thickness of the cap layer 36 at the position PS2. A length indicated by a double-headed arrow BS2 can be the thickness of the base layer 34 at the position PS2. A ratio CS2/BS2 of the thickness CS2 of the cap layer 36 to the thickness BS2 of the base layer 34 can be a cap layer thickness ratio ARs2 at the position PS2.

A length indicated by a double-headed arrow CS3 along the thickness reference line LS3 can be the thickness of the cap layer 36 at the position PS3. A length indicated by a double-headed arrow BS3 can be the thickness of the base layer 34 at the position PS3. A ratio CS3/BS3 of the thickness CS3 of the cap layer 36 to the thickness BS3 of the base layer 34 can be a cap layer thickness ratio ARs3 at the position PS3.

In the tire 2, a proportion ARs of the cap layer 36 occupying the shoulder land portion 32s can be represented as the average value of a ratio CS/BS of a cap layer thickness CS to a base layer thickness BS in the shoulder land portion 32s. Specifically, the cap layer proportion ARs can be represented as the average value of the cap layer thickness ratio CS1/BS1 at the position PS1, the cap layer thickness ratio CS2/BS2 at the position PS2, and the cap layer thickness ratio CS3/BS3 at the position PS3.

In the tire 2, each end BE of the base layer 34 can be located axially inward of the end 20e of the belt 20. In the tire 2, the cap layer 36 covering a portion of the base layer 34 at the end BE thereof can be thicker than in the conventional tires. In each shoulder portion, the base layer 34 can be less likely to be exposed. During limit running in which a relatively large load acts on the shoulder portion, the tread 4 can be less likely to peel off.

In the tire 2, the proportion ARs of the cap layer 36 occupying the shoulder land portion 32s can be higher than that in the conventional tires. In other words, the proportion of the base layer 34 occupying the shoulder land portion 32s can be relatively low. The cap layer 36 can be harder and more likely to generate heat than the base layer 34. Therefore, there may be a concern that rolling resistance may increase, ride comfort may decrease, and road noise may increase, decreasing quietness.

However, in the tire 2 according to one or more embodiments of the present disclosure, the cap layer proportion ARc of the crown land portion 32c can be not less than 1.5 and not greater than 3.5, the cap layer proportion ARm of the middle land portion 32m can be equal to or higher than the cap layer proportion ARc of the crown land portion 32c, and the cap layer proportion ARs of the shoulder land portion 32s can be higher than the cap layer proportion ARm of the middle land portion 32m and not less than 5.0 and not greater than 9.5, for instance. In other words, the proportion of the base layer 34 occupying the land portion 32 can be lower in the shoulder land portion 32s and higher in the crown land portion 32c and the middle land portion 32m. The base layer 34 can be softer and less likely to generate heat than the cap layer 36. The crown land portion 32c and the middle land portion 32m having a higher base layer proportion can contribute to suppressing each of an increase in rolling resistance, a decrease in ride comfort, and a decrease in quietness.

The tire 2 according to one or more embodiments of the present disclosure can suppress occurrence of tread peeling while suppressing an increase in rolling resistance, a decrease in ride comfort, and a decrease in quietness.

From the viewpoint that the tire 2 can effectively suppress occurrence of tread peeling while suppressing each of an increase in rolling resistance, a decrease in ride comfort, and a decrease in quietness, according to one or more embodiments the cap layer proportion ARc of the crown land portion 32c can be not less than 2.0 and not greater than 3.0. From the same viewpoint, the cap layer proportion ARm of the middle land portion 32m can be equal to the cap layer proportion ARc of the crown land portion 32c. From the same viewpoint, the cap layer proportion ARs of the shoulder land portion 32s can be not less than 7.0 and not greater than 9.0, for instance. According to one or more embodiments, the cap layer proportion ARc of the crown land portion 32c can be not less than 2.0 and not greater than 3.0, the cap layer proportion ARm of the middle land portion 32m can be equal to the cap layer proportion ARc of the crown land portion 32c, and the cap layer proportion ARs of the shoulder land portion 32s can be not less than 7.0 and not greater than 9.0, for instance.

For example, as shown in FIG. 1, each end CE of the cap layer 36 can be located axially outward of the end 50e of the inner belt ply 50, that is, the end 20e of the belt 20. The position of each end CE of the cap layer 36 may coincide with the position of the end 20e of the belt 20 in the axial direction. As described above, each end BE of the base layer 34 can be located axially inward of the end 20e of the belt 20. Each end BE of the base layer 34 can be covered with the cap layer 36 having a sufficient thickness. In each shoulder portion, the base layer 34 can be less likely to be exposed. During limit running in which a relatively large load acts on the shoulder portion, the tread 4 can be less likely to peel off. The tire 2, according to one or more embodiments of the present disclosure, can effectively suppress occurrence of tread peeling. From this viewpoint, the position of each end CE of the cap layer 36 can coincide with the position of the end 20e of the belt 20 in the axial direction, or each end CE of the cap layer 36 can be located axially outward of the end 20e of the belt 20, and each end CE of the cap layer 36 can be located axially outward of the end 20e of the belt 20.

From the same viewpoint, a ratio WTC/WBU of the width WTC of the cap layer 36 to the width WBU of the belt 20 can be not less than 100%, for instance, not less than 103%. From the viewpoint of appropriately maintaining the volume of the cap layer 36 included in the shoulder land portion 32s and effectively suppressing the influence of the cap layer 36 included in the shoulder land portion 32s on ride comfort and quietness, the ratio WTC/WBU can be not greater than 110%, for instance, not greater than 107%.

As described above, each end BE of the base layer 34 can be located axially inward of the end 20e of the belt 20. In the tire 2, each end BE of the base layer 34 can be located near the end 52e of the outer belt ply 52. Specifically, a ratio WTB/WBS of the width WTB of the base layer 34 to the width WBS of the outer belt ply 52 can be not less than 90% and not greater than 110%, for instance.

When the ratio WTB/WBS is set to be not less than 90%, the base layer 34 can effectively contribute to reduction of rolling resistance. In addition, in the shoulder land portion 32s, the base layer 34 can contribute to suppressing each of a decrease in responsiveness, ride comfort, and quietness. From these viewpoints, the ratio WTB/WBS can be not less than 95%, for instance, not less than 98%.

When the ratio WTB/WBS is set to be not greater than 110%, each end BE of the base layer 34 can be covered with the cap layer 36 having a sufficient thickness. The tire 2 can effectively suppress occurrence of tread peeling. From this viewpoint, the ratio WTB/WBS can be not greater than 105% and further preferably not greater than 102%.

For example, as shown in FIG. 6, the base layer 34 can be tapered outward in the axial direction in the shoulder land portion 32s. Each end BE of the base layer 34 can be covered with the cap layer 36 having a sufficient thickness. In each shoulder portion, the base layer 34 can be less likely to be exposed. During limit running in which a relatively large load acts on the shoulder portion, the tread 4 can be less likely to peel off. The tire 2 can effectively suppress occurrence of tread peeling. From this viewpoint, the base layer 34 can be tapered outward in the axial direction in the shoulder land portion 32s.

From the same viewpoint, the cap layer thickness ratio ARs3 at the position PS3 can be preferably not greater than 0.4 times and more preferably not greater than 0.3 times the cap layer thickness ratio ARs1 at the position PS1. From the viewpoint that the base layer 34 can contribute to reduction of rolling resistance, the cap layer thickness ratio ARs3 at the position PS3 can be preferably not less than 0.1 times and more preferably not less than 0.2 times the cap layer thickness ratio ARs1 at the position PS1.

In FIG. 3, a length indicated by a double-headed arrow CW can be the ground-contact width of the standard ground-contact surface. The ground-contact width CW can be represented as the distance in the axial direction from the first ground-contact end SEs1 to the second ground-contact end SEs2. An alternate long and short dash line LPs can indicate a ground-contact width center line of the standard ground-contact surface. A length indicated by a double-headed arrow CG, that is, the length of a line of intersection of the standard ground-contact surface and the ground-contact width center line LPs, can be the ground-contact length at the ground-contact width center of the standard ground-contact surface.

In the tire 2, the ground-contact width CW of the standard ground-contact surface can be not less than 70% and not greater than 80% of the nominal cross-sectional width of the tire 2, for instance. Accordingly, the tire 2 can come into contact with a road surface over a sufficiently wide area. The tire 2 according to one or more embodiments of the present disclosure can effectively suppress a decrease in responsiveness due to the increase of the base layer proportion in the crown land portion 32c and the middle land portion 32m. The tire 2 according to one or more embodiments of the present disclosure can maintain good steering stability.

In FIG. 3, each double-headed arrow WGM can indicate the groove width of the middle circumferential groove 30m in the standard ground-contact surface. Each double-headed arrow WGS can indicate the groove width of the shoulder circumferential groove 30s in the standard ground-contact surface.

A solid line LA can be a straight line that passes through the center of the ground-contact length CG and extends in the axial direction. The groove width WGM and the groove width WGS can be measured along the straight line LA.

In the tire 2 according to one or more embodiments of the present disclosure, the sum of the groove widths of the plurality of circumferential grooves 30 included in the standard ground-contact surface, that is, a sum WGT of the groove widths WGM of the two middle circumferential grooves 30m and the groove widths WGS of the two shoulder circumferential grooves 30s included in the standard ground-contact surface, can be adjusted. Specifically, the ratio (WGT/CW) of the sum WGT of the groove widths of the plurality of circumferential grooves 30 included in the standard ground-contact surface to the ground-contact width CW of the standard ground-contact surface can be not less than 20% and not greater than 30%, for instance. Accordingly, in the tire 2 according to one or more embodiments of the present disclosure, responsiveness, ride comfort, and quietness can be well balanced. From this viewpoint, for instance, the ratio (WGT/CW) can be more preferably not less than 22% and not greater than 28% and further preferably not less than 24% and not greater than 26%.

From the viewpoint that the tire 2 can suppress occurrence of tread peeling while suppressing an increase in rolling resistance, for instance, a decrease in responsiveness, a decrease in ride comfort, and a decrease in quietness, it may be preferable that the ground-contact width CW of the standard ground-contact surface is not less than 70% and not greater than 80% of the nominal cross-sectional width of the tire 2, and the ratio (WGT/CW) of the sum WGT of the groove widths of the plurality of circumferential grooves 30 included in the standard ground-contact surface to the ground-contact width CW of the standard ground-contact surface is not less than 20% and not greater than 30%, for instance.

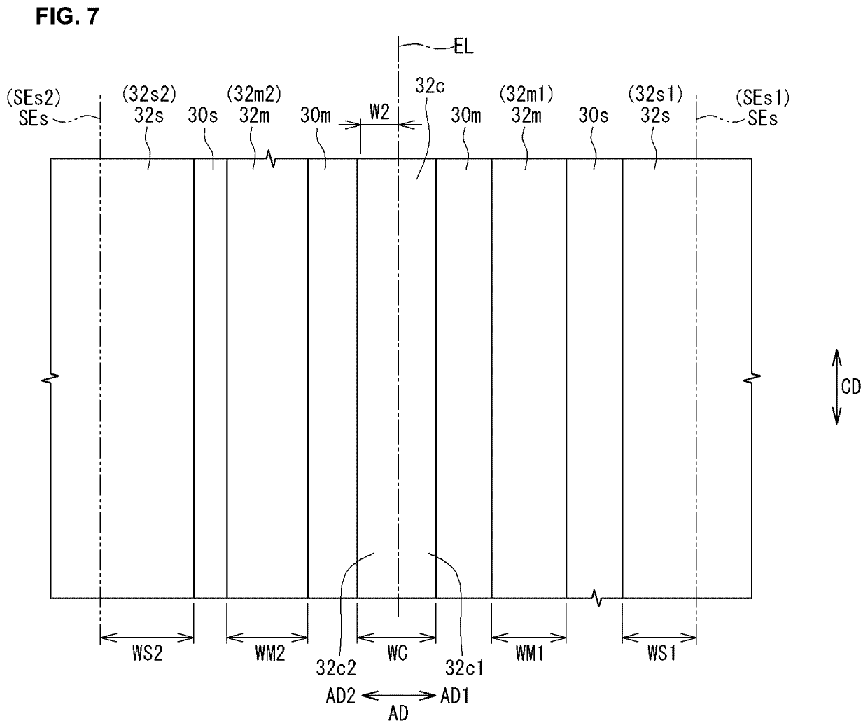

FIG. 7 shows a modification of the tread pattern according to one or more embodiments of the present disclosure. In FIG. 7 as well, as in FIG. 2, for convenience of description, only the four circumferential grooves 30 are shown as the grooves 28 which form the tread pattern. In FIG. 7, a direction indicated by an arrow AD1 can correspond to the first reference end Te1 side, and a direction indicated by an arrow AD2 can correspond to the second reference end Te2 side.

In this tread pattern, the four circumferential grooves 30 can be arranged asymmetrically with respect to the equator plane EL. Therefore, the five land portions 32 can also be arranged asymmetrically with respect to the equator plane EL.

In the tread pattern shown in FIG. 7, the width WC of the crown land portion 32c can be taken into consideration. Specifically, the crown land portion 32c can be formed so as to have a width WC wider than the width WC of the crown land portion 32c shown in FIG. 2. Accordingly, in a vehicle on which the tire 2 is mounted, a relatively high cornering force can be generated at each front tire. The tire 2 according to one or more embodiments of the present disclosure can contribute to suppression of a response delay of the front tire. The tire 2 according to one or more embodiments of the present disclosure can effectively suppress an increase in rolling resistance and occurrence of tread peeling while suppressing a decrease in responsiveness. From this viewpoint, for instance, a ratio WC/CW of the width WC of the crown land portion 32c to the ground-contact width CW of the standard ground-contact surface can be not less than 14%, for instance.

The ratio WC/CW can be not greater than 16%, as an example, according to one or more embodiments of the present disclosure. Accordingly, in a vehicle on which the tire 2 is mounted, a relatively high cornering force can be generated in a well-balanced manner at each front tire and each rear tire. The tire 2 according to one or more embodiments of the present disclosure can contribute to improvement of linearity.

In the tire 2, the middle land portion 32m on the first reference end Te1 side (hereinafter referred to as first middle land portion 32m1) can have a width WM1 substantially equal to the width WS1 of the shoulder land portion 32s on the first reference end Te1 side (hereinafter referred to as first shoulder land portion 32s1). The crown land portion 32c can have a width WC substantially equal to the width WM1 of the first middle land portion 32m1, or has a width WC wider than the width WM1. The middle land portion 32m on the second reference end Te2 side (hereinafter referred to as second middle land portion 32m2) can have a width WM2 substantially equal to the width WC of the crown land portion 32c, or has a width WM2 wider than the width WC. The shoulder land portion 32s on the second reference end Te2 side (hereinafter referred to as second shoulder land portion 32s2) can have a width WS2 wider than the width WM2 of the second middle land portion 32m2. By adopting the tread pattern in FIG. 7, for instance, the ratio of a cornering force at each rear tire to a cornering force at each front tire can be effectively increased compared to the conventional tires. When the tire 2 according to one or more embodiments of the present disclosure is mounted on a vehicle, linearity can be improved. The tire 2 according to one or more embodiments of the present disclosure can effectively suppress an increase in rolling resistance and occurrence of tread peeling while improving linearity, that is, while improving the steering stability of the vehicle.

The width WS1 of the first shoulder land portion 32s1 can be not less than 90% and not greater than 100% of the width WC of the crown land portion 32c, as an example.

When the width WS1 is set to be not less than 90% of the width WC, the crown land portion 32c, the first middle land portion 32m1, and the second middle land portion 32m2 can be formed with appropriate widths in the tire 2. When the tire 2 according to one or more embodiments of the present disclosure is mounted on a vehicle, a relatively high cornering force can be generated in a well-balanced manner at each front tire and each rear tire, for instance, so that linearity is improved.

When the width WS1 is set to be not greater than 100% of the width WC, the crown land portion 32c, the first middle land portion 32m1, and the second middle land portion 32m2 can be formed with appropriate widths in the tire 2. When the tire 2 according to one or more embodiments of the present disclosure is mounted on a vehicle, a relatively high cornering force can be generated at each front tire, for instance, so that a response delay of the front tire can be suppressed.

The width WM1 of the first middle land portion 32m1 can be not less than 90% and not greater than 100% of the width WC of the crown land portion 32c, according to one or more embodiments of the present disclosure.

When the width WM1 is set to be not less than 90% of the width WC, a relatively high cornering force can be generated at each front tire when the tire 2 is mounted on a vehicle. The tire 2 according to one or more embodiments of the present disclosure can contribute to suppression of a response delay of the front tire.

When the width WM1 is set to be not greater than 100% of the width WC, a relatively high cornering force can be generated in a well-balanced manner at each front tire and each rear tire when the tire 2 is mounted on a vehicle. The tire 2 according to one or more embodiments of the present disclosure can contribute to improvement of linearity.

The width WM2 of the second middle land portion 32m2 can be not less than 97% and not greater than 107% of the width WC of the crown land portion 32c, as an example.

When the width WM2 is set to be not less than 97% of the width WC, a relatively high cornering force can be generated at each front tire when the tire 2 is mounted on a vehicle. The tire 2 according to one or more embodiments of the present disclosure can contribute to suppression of a response delay of the front tire.

When the width WM2 is set to be not greater than 107% of the width WC, a relatively high cornering force can be generated in a well-balanced manner at each front tire and each rear tire when the tire 2 is mounted on a vehicle. The tire 2 according to one or more embodiments of the present disclosure can contribute to improvement of linearity.

The width WS2 of the second shoulder land portion 32s2 can be not less than 114% and not greater than 124% of the width WC of the crown land portion 32c, as an example.

When the width WS2 is set to be not less than 114% of the width WC, the crown land portion 32c, the first middle land portion 32m1, and the second middle land portion 32m2 can be formed with appropriate widths in the tire 2. When the tire 2 according to one or more embodiments of the present disclosure is mounted on a vehicle, a relatively high cornering force can be generated in a well-balanced manner at each front tire and each rear tire, for instance, so that linearity can be improved.

When the width WS2 is set to be not greater than 124% of the width WC, the crown land portion 32c, the first middle land portion 32m1, and the second middle land portion 32m2 can be formed with appropriate widths in the tire 2. When the tire 2 according to one or more embodiments of the present disclosure is mounted on a vehicle, a relatively high cornering force can be generated at each front tire, for instance, so that a response delay of the front tire can be suppressed.

In the crown land portion 32c shown in FIG. 7, the width center thereof can be located on the second reference end Te2 side with respect to the equator plane EL. That is, when the crown land portion 32c is divided into a first portion 32cl on the first reference end Te1 side and a second portion 32c2 on the second reference end Te2 side by the equator plane EL, the width of the second portion 32c2 can be wider than the width of the first portion 32c1. Accordingly, the tire 2 according to one or more embodiments of the present disclosure can effectively increase the ratio of a cornering force at each rear tire to a cornering force at each front tire while effectively increasing the cornering force generated at each front tire. The tire 2 according to one or more embodiments of the present disclosure can effectively suppress an increase in rolling resistance and occurrence of tread peeling while improving responsiveness and linearity.

In FIG. 7, a double-headed arrow W2 can indicate the width of the second portion 32c2. The width W2 can be represented as the distance in the axial direction from the equator plane EL to the edge on the second reference end Te2 side of the crown land portion 32c.

From the viewpoint that the tire 2 can effectively suppress an increase in rolling resistance and occurrence of tread peeling while improving responsiveness and linearity, for instance, the ratio (W2/WC) of the width W2 of the second portion 32c2 to the width WC of the crown land portion 32c can be not less than 51% and not greater than 55%.

From the viewpoint that the tire 2 can effectively suppress an increase in rolling resistance and occurrence of tread peeling while improving responsiveness and linearity, for instance, in the case where the tread pattern of the tire 2 includes four circumferential grooves 30 and five land portions 32 are formed in the tread 4, the ratio WC/CW of the width WC of the crown land portion 32c to the ground-contact width CW of the standard ground-contact surface can be not less than 14% and not greater than 16%. In this case, it can be more preferable that the width WS1 of the shoulder land portion 32s1 on the first reference end Te1 side is not less than 90% and not greater than 100% of the width WC of the crown land portion 32c, the width WM1 of the middle land portion 32m1 on the first reference end Te1 side is not less than 90% and not greater than 100% of the width WC of the crown land portion 32c, the width WM2 of the middle land portion 32m2 on the second reference end Te2 side is not less than 97% and not greater than 107% of the width WC of the crown land portion 32c, the width WS2 of the shoulder land portion 32s2 on the second reference end Te2 side is not less than 114% and not greater than 124% of the width WC of the crown land portion 32c, and the ratio (W2/WC) of the width W2 of the second portion 32c2 of the crown land portion 32c to the width WC of the crown land portion 32c is not less than 51% and not greater than 55%. In particular, in the case where the ground-contact width CW of the standard ground-contact surface is not less than 70% and not greater than 80% of the nominal cross-sectional width of the tire 2 and the ratio (WGT/CW) of the sum WGT of the groove widths of the plurality of circumferential grooves 30 included in the standard ground-contact surface to the ground-contact width CW of the standard ground-contact surface is not less than 20% and not greater than 30%, the tread pattern shown in FIG. 7 can more effectively contribute to improvement of responsiveness and linearity. The tire 2 according to one or more embodiments can effectively suppress an increase in rolling resistance and occurrence of tread peeling while improving responsiveness and linearity.

Thus, according to one or more embodiments of the present disclosure, a tire that can suppress occurrence of tread peeling while suppressing an increase in rolling resistance, can be obtained. In particular, a tire according to one or more embodiments can exhibit an effect in a tire that can have a nominal cross-sectional width of not less than 215 mm and not greater than 325 mm and a load index (LI) of not less than 90.

### EXAMPLES

Hereinafter, one or more embodiments of the present disclosure will be described in further detail by means of examples, etc., but one or more embodiments of the present disclosure are not limited to these examples.

### Example 1

A tire (tire size=245/50R19) having the basic structure shown in FIG. 1 and having specifications shown in Table 1 below was obtained.

As shown in FIG. 6, each end of the base layer was located near the end of the outer belt ply. This is represented as “FIG. 6” in the cell for “CAP/BASE structure” in Table 1 below.

The ratio WTB/WBS of the width WTB of the base layer to the width WBS of the outer belt ply was 100%.

The cap layer proportion ARc of the crown land portion, the cap layer proportion ARm of the middle land portion, and the cap layer proportion ARs of the shoulder land portion are as shown in Table 1 below.

The four circumferential grooves provided on the tread were arranged as shown in FIG. 2. This is represented as “FIG. 2” in the cell for “Tread pattern” in Table 1 below.

The ratio WGT/CW of the sum WGT of the groove widths of the plurality of circumferential grooves included in the standard ground-contact surface to the ground-contact width CW of the standard ground-contact surface, the ratio WS2/WC of the width WS2 of the second shoulder land portion to the width WC of the crown land portion, the ratio WM2/WC of the width WM2 of the second middle land portion to the width WC of the crown land portion, the ratio WM1/WC of the width WM1 of the first middle land portion to the width WC of the crown land portion, the ratio WS1/WC of the width WS1 of the first shoulder land portion to the width WC of the crown land portion, the ratio W2/WC of the width W2 of the second portion of the crown land portion to the width WC of the crown land portion, and the ratio WC/CW of the width WC of the crown land portion to the ground-contact width CW of the standard ground-contact surface are as shown in Table 1 below.

### Comparative Examples 1 and 2

Tires of Comparative Examples 1 and 2 are conventional tires (tire size=245/50R19). The specifications of the tires of Comparative Examples 1 and 2 are as shown in Table 1 below.

### Example 2

A tire of Example 2 was obtained in the same manner as Example 1, except that the arrangement of the circumferential grooves was changed as shown in FIG. 7, and the ratio WGT/CW, the ratio WS2/WC, the ratio WM2/WC, the ratio WM1/WC, the ratio WS1/WC, the ratio W2/WC, and the ratio WC/CW were set as shown in Table 1 below.

### Example 3

A tire of Example 3 was obtained in the same manner as Example 2, except that the ratio WTB/WBS was set as shown in Table 1 below.

### Comparative Examples 3 and 4

Tires of Comparative Examples 3 and 4 were obtained in the same manner as Example 2, except that the cap layer proportion ARc of the crown land portion was set as shown in Table 1 below.

### Example 4 and Comparative Example 5

Tires of Example 4 and Comparative Example 5 were obtained in the same manner as Example 2, except that the cap layer proportion ARm of the middle land portion was set as shown in Table 2 below.

### Comparative Examples 6 and 7

Tires of Comparative Examples 6 and 7 were obtained in the same manner as Example 2, except that the cap layer proportion ARs of the shoulder land portion was set as shown in Table 2 below.

### Examples 5 to 12

Tires of Examples 5 to 12 were obtained in the same manner as Example 1, except that the ratio WS2/WC, the ratio WM2/WC, the ratio WM1/WC, the ratio WS1/WC, and the ratio WC/CW were set as shown in Tables 2 and 3 below.

### [Rolling Resistance (RRC)]

Using a rolling resistance testing machine, a rolling resistance coefficient (RRC) was measured when a test tire ran on a drum at a speed of 80 km/h under the following conditions. The results are shown in the cells for “RRC” in Tables 1 to 3 below as indexes with the result of Comparative Example 1 being regarded as 100. The higher the value is, the lower the rolling resistance of the tire is.
Rim: 7.5 inches
Internal pressure: 250 kPa
Vertical load: 7.26 kN

### [Running Test]

Test tires were fitted onto rims (size=7.5 inches) and inflated with air to adjust the internal pressures of the tires to 250 kPa. The tires were mounted to a test vehicle (passenger car). The test vehicle was driven on a test course with a dry road surface, and sensory evaluation was performed for responsiveness and ride comfort. The results are shown in the cells for “Responsiveness” and “Ride comfort” in Tables 1 to 3 below as indexes with the result of Comparative Example 1 being regarded as 100. The higher the value is, the more a decrease in responsiveness or ride comfort is suppressed and the better the result is.

### [Durability]

For each tire that had undergone the above-described running test, the appearance was observed to check the state of occurrence of tread peeling, and the size (area) of a portion where peeling occurred was obtained. The results are shown in the cells for “Durability” in Tables 1 to 3 below as indexes with the result of Comparative Example 1 being regarded as 100. The higher the value is, the more tread peeling is suppressed.

### [Quietness (Road Noise: R/N)]

Test tires were fitted onto rims (size=7.5 inches) and inflated with air to adjust the internal pressures of the tires to 250 kPa. The tires were mounted to a test vehicle (front-wheel-drive passenger car having an engine displacement of 2000 cc). The sound pressure level of cavity resonance sound (road noise) when the test vehicle was driven at 30 km/h on a test course with a dry road surface was measured using a microphone installed at an ear position of the driver's seat on the window side. The results are shown in the cells for “R/N” in Tables 1 to 3 below as indexes with the result of Comparative Example 1 being regarded as 100. The higher the value is, the better the result is. The cavity resonance sound is a peak value around 240 Hz.

### [Quietness (Pattern Noise: P/N)]

Test tires were fitted onto rims (rim width=7.5 inches) and inflated with air to adjust the internal pressures of the tires to 250 kPa. The tires were mounted to a test vehicle (front-wheel-drive passenger car having an engine displacement of 2000 cc). Sensory evaluation was performed for whooshing noise when the test vehicle was driven at 100 km/h on a test course with a dry road surface. The results are shown in the cells for “P/N” in Tables 1 to 3 below as indexes with the result of Comparative Example 1 being regarded as 100. The higher the value is, the better the result is.

### [Combined Performance]

The total of the index values obtained in the respective evaluations was calculated. The results are shown in the cells for “Combined” in Tables 1 to 3 below. The higher the value is, the better the performance is.

TABLE 1

| | Comp. | Comp. | | | | Comp. | Comp. |
|---|---|---|---|---|---|---|---|
| | Ex. 1 | Ex. 2 | Ex. 1 | Ex. 2 | Ex. 3 | Ex. 3 | Ex. 4 |
| CAP/BASE structure | FIG. 8 | FIG. 9 | FIG. 6 | FIG. 6 | FIG. 6 | FIG. 6 | FIG. 6 |
| WTB/WBS [%] | 115 | 107 | 100 | 100 | 85 | 100 | 100 |
| ARc [%] | 4.0 | 4.0 | 2.3 | 2.3 | 2.3 | 1.0 | 5.0 |
| ARm [%] | 4.0 | 4.0 | 2.3 | 2.3 | 2.3 | 2.3 | 2.3 |
| ARs [%] | 4.0 | 4.0 | 9.0 | 9.0 | 9.0 | 9.0 | 9.0 |
| Tread pattern | FIG. 2 | FIG. 2 | FIG. 2 | FIG. 7 | FIG. 7 | FIG. 7 | FIG. 7 |
| WGT/CW [%] | 23 | 23 | 23 | 25 | 25 | 25 | 25 |
| WS2/WC [%] | 140 | 140 | 140 | 119 | 119 | 119 | 119 |
| WM2/WC [%] | 125 | 125 | 125 | 102 | 102 | 102 | 102 |
| WM1/WC [%] | 125 | 125 | 125 | 95 | 95 | 95 | 95 |
| WS1/WC [%] | 140 | 140 | 140 | 95 | 95 | 95 | 95 |
| W2/WC [%] | 50 | 50 | 50 | 53 | 53 | 53 | 53 |
| WC/CW [%] | 12.2 | 12.2 | 12.2 | 14.7 | 14.7 | 14.7 | 14.7 |
| RRC | 100 | 98 | 98 | 98 | 97 | 102 | 97 |
| Durability | 100 | 110 | 115 | 115 | 120 | 115 | 115 |
| Responsiveness | 100 | 110 | 98 | 100 | 120 | 80 | 107 |
| Ride comfort | 100 | 90 | 95 | 100 | 85 | 105 | 95 |
| R/N | 100 | 95 | 100 | 100 | 90 | 105 | 95 |
| P/N | 100 | 95 | 100 | 100 | 90 | 105 | 95 |
| Combined | 600 | 598 | 606 | 613 | 602 | 612 | 604 |

TABLE 2

| | Comp. | | Comp. | Comp. | | |
|---|---|---|---|---|---|---|
| | Ex. 5 | Ex. 4 | Ex. 6 | Ex. 7 | Ex. 5 | Ex. 6 |
| CAP/BASE structure | FIG. 6 | FIG. 6 | FIG. 6 | FIG. 6 | FIG. 6 | FIG. 6 |
| WTB/WBS [%] | 100 | 100 | 100 | 100 | 100 | 100 |
| ARc [%] | 2.3 | 2.3 | 2.3 | 2.3 | 2.3 | 2.3 |
| ARm [%] | 1.0 | 5.0 | 2.3 | 2.3 | 2.3 | 2.3 |
| ARs [%] | 9.0 | 9.0 | 3.0 | 10.0 | 9.0 | 9.0 |
| Tread pattern | FIG. 7 | FIG. 7 | FIG. 7 | FIG. 7 | FIG. 7 | FIG. 7 |
| WGT/CW [%] | 25 | 25 | 25 | 25 | 25 | 25 |
| WS2/WC [%] | 119 | 119 | 119 | 119 | 125 | 113 |
| WM2/WC [%] | 102 | 102 | 102 | 102 | 102 | 102 |
| WM1/WC [%] | 95 | 95 | 95 | 95 | 95 | 95 |
| WS1/WC [%] | 95 | 95 | 95 | 95 | 95 | 95 |
| W2/WC [%] | 53 | 53 | 53 | 53 | 53 | 53 |
| WC/CW [%] | 14.7 | 14.7 | 14.7 | 14.7 | 14.5 | 14.9 |
| RRC | 102 | 97 | 102 | 96 | 98 | 98 |
| Durability | 115 | 115 | 115 | 115 | 115 | 115 |
| Responsiveness | 85 | 105 | 90 | 104 | 110 | 88 |
| Ride comfort | 103 | 97 | 101 | 98 | 90 | 105 |
| R/N | 103 | 97 | 101 | 98 | 90 | 105 |
| P/N | 103 | 97 | 101 | 98 | 100 | 100 |
| Combined | 611 | 608 | 610 | 609 | 603 | 611 |

TABLE 3

| | Ex. 7 | Ex. 8 | Ex. 9 | Ex. 10 | Ex. 11 | Ex. 12 |
|---|---|---|---|---|---|---|
| CAP/BASE structure | FIG. 6 | FIG. 6 | FIG. 6 | FIG. 6 | FIG. 6 | FIG. 6 |
| WTB/WBS [%] | 100 | 100 | 100 | 100 | 100 | 100 |
| ARc [%] | 2.3 | 2.3 | 2.3 | 2.3 | 2.3 | 2.3 |
| ARm [%] | 2.3 | 2.3 | 2.3 | 2.3 | 2.3 | 2.3 |
| ARs [%] | 9.0 | 9.0 | 9.0 | 9.0 | 9.0 | 9.0 |
| Tread pattern | FIG. 7 | FIG. 7 | FIG. 7 | FIG. 7 | FIG. 7 | FIG. 7 |
| WGT/CW [%] | 25 | 25 | 25 | 25 | 25 | 25 |
| WS2/WC [%] | 119 | 119 | 119 | 119 | 119 | 119 |
| WM2/WC [%] | 108 | 96 | 102 | 102 | 102 | 102 |
| WM1/WC [%] | 95 | 95 | 101 | 89 | 95 | 95 |
| WS1/WC [%] | 95 | 95 | 95 | 95 | 101 | 89 |
| W2/WC [%] | 53 | 53 | 53 | 53 | 53 | 53 |
| WC/CW [%] | 14.5 | 14.9 | 14.5 | 14.9 | 14.5 | 14.9 |
| RRC | 98 | 98 | 98 | 98 | 98 | 98 |
| Durability | 115 | 115 | 115 | 115 | 115 | 115 |
| Responsiveness | 105 | 91 | 102 | 94 | 10 | 95 |
| Ride comfort | 92 | 104 | 97 | 102 | 98 | 101 |
| R/N | 92 | 104 | 97 | 102 | 98 | 101 |
| P/N | 100 | 100 | 100 | 100 | 100 | 100 |
| Combined | 602 | 612 | 609 | 611 | 610 | 610 |

As shown in Tables 1 to 3, it is confirmed that in each Example, occurrence of tread peeling is suppressed while suppressing an increase in rolling resistance. From the evaluation results, advantages of the present invention are clear.

The above-described technology capable of suppressing occurrence of tread peeling while suppressing an increase in rolling resistance can be applied to various tires.

### [Additional Note]

One or more embodiments of the present disclosure can include aspects described below.

[1.] A tire including a pair of beads, a carcass extending on and between the pair of beads, a tread located radially outward of the carcass, and a belt located between the tread and the carcass, wherein
the tread includes a base layer and a cap layer covering the entire base layer,
the cap layer is harder than the base layer,
a loss tangent at 70° C. of the base layer is lower than a loss tangent at 30° C. of the cap layer,
each end of the base layer is located axially inward of an end of the belt,
the belt includes an inner belt ply and an outer belt ply located radially outward of the inner belt ply,
each end of the outer belt ply is located axially inward of an end of the inner belt ply,
the tread has a tread pattern including a plurality of circumferential grooves, thereby forming a plurality of land portions aligned in an axial direction in the tread,
the plurality of land portions include, in a portion between an equator plane of the tire and an end of the tread, a crown land portion located on the equator plane side, a shoulder land portion located on the tread end side, and a middle land portion located between the crown land portion and the shoulder land portion,
a proportion ARc of the cap layer occupying the crown land portion is represented as an average value of a ratio of a cap layer thickness to a base layer thickness in the crown land portion,
a proportion ARm of the cap layer occupying the middle land portion is represented as an average value of a ratio of a cap layer thickness to a base layer thickness in the middle land portion,
a proportion ARs of the cap layer occupying the shoulder land portion is represented as an average value of a ratio of a cap layer thickness to a base layer thickness in the shoulder land portion,
the cap layer proportion ARc of the crown land portion is not less than 1.5 and not greater than 3.5,
the cap layer proportion ARm of the middle land portion is equal to or higher than the cap layer proportion ARc of the crown land portion, and
the cap layer proportion ARs of the shoulder land portion is higher than the cap layer proportion ARm of the middle land portion and not less than 5.0 and not greater than 9.5.

[2.] The tire according to [1] above, wherein a position of each end of the cap layer coincides with a position of the end of the belt in the axial direction, or each end of the cap layer is located axially outward of the end of the belt.

[3.] The tire according to [1] or [2] above, wherein
a ground-contact surface obtained when the tire is fitted onto a standardized rim, an internal pressure of the tire is adjusted to 250 kPa, a camber angle of the tire is set to 0 degrees, a vertical load is applied to the tire, and the tire is brought into contact with a road surface composed of a flat surface, is a standard ground-contact surface,
the vertical load applied to the tire is not less than 60% and not greater than 80% of a load indicated by a load index of the tire,
a ground-contact width of the standard ground-contact surface is not less than 70% and not greater than 80% of a nominal cross-sectional width of the tire, and a ratio of a sum of groove widths of the plurality of circumferential grooves included in the standard ground-contact surface to the ground-contact width of the standard ground-contact surface is not less than 20% and not greater than 30%.

[4.] The tire according to any one of [1] to [3] above, wherein
the tread pattern includes the four circumferential grooves, thereby forming the five land portions in the tread,
the five land portions are the crown land portion located on the equator plane, a pair of the middle land portions located axially outward of the crown land portion, and a pair of the shoulder land portions located axially outward of the respective middle land portions, and
a ratio of a width of the crown land portion to the ground-contact width of the standard ground-contact surface is not less than 14% and not greater than 16%.

[5.] The tire according to any one of [1] to [4] above, wherein
of the two ends of the tread, one end located on an inner side in a width direction of a vehicle when the tire is mounted on the vehicle is a first reference end, and another end is a second reference end,
a width of the shoulder land portion on the first reference end side is not less than 90% and not greater than 100% of the width of the crown land portion,
a width of the middle land portion on the first reference end side is not less than 90% and not greater than 100% of the width of the crown land portion,
a width of the middle land portion on the second reference end side is not less than 97% and not greater than 107% of the width of the crown land portion, and
a width of the shoulder land portion on the second reference end side is not less than 114% and not greater than 124% of the width of the crown land portion.

[6.] The tire according to any one of [1] to [5] above, wherein
the first reference end side of the crown land portion with respect to the equator plane is a first portion, and the second reference end side of the crown land portion with respect to the equator plane is a second portion, and
a ratio of a width of the second portion to the width of the crown land portion is not less than 51% and not greater than 55%.

[7.] The tire according to any one of [1] to [6] above, wherein
the loss tangent at 70° C. of the base layer is not less than 0.02 and not greater than 0.10, and
the loss tangent at 30° C. of the cap layer is not less than 0.12 and not greater than 0.40.

[8.] The tire according to any one of [1] to [7] above, wherein a ratio of the loss tangent at 30° C. of the base layer to the loss tangent at 70° C. of the cap layer is not less than 0.10 and not greater than 0.38.

[9.] The tire according to any one of [1] to [8] above, wherein the base layer is tapered outward in the axial direction in the shoulder land portion.

[10.] The tire according to any one of [1] to [9] above, wherein
the cap layer proportion ARc of the crown land portion is not less than 2.0 and not greater than 3.0, and/or
the cap layer proportion ARs of the shoulder land portion is higher than the cap layer proportion ARm of the middle land portion and not less than 7.0 and not greater than 9.0.

[11.] The tire according to any one of [1] to above, wherein the tire has a nominal cross-sectional width of not less than 215 mm and not greater than 325 mm and a load index (LI) of not less than 90.

[12.] The tire according to any one of [1] to above, wherein
groove depth of each circumferential groove is not less than 5.0 mm and not greater than 7.5 mm, and
groove width of each circumferential groove is not less than 5.0 mm and not greater than 20.0 mm.

[13.] The tire according to any one of [1] to above, wherein
a hardness of the cap layer is not less than 60 and not greater than 70, and
a hardness of the base layer is not less than 50 and not greater than 65.

[14.] The tire according to any one of [1] to above, wherein
a difference between a hardness of the cap layer and a hardness of the base layer is not less than 10 and not greater than 20.

[15.] The tire according to any one of [1] to above, wherein each end of the cap layer is axially outward of the end of the belt.

[16.] A tire comprising a pair of beads, a carcass extending on and between the pair of beads, a tread located radially outward of the carcass, and a belt located between the tread and the carcass, wherein
the tread includes a base layer and a cap layer covering the entire base layer,
the cap layer is harder than the base layer,
a loss tangent at 70° C. of the base layer is lower than a loss tangent at 30° C. of the cap layer,
each end of the base layer is located axially inward of an end of the belt,
the belt includes an inner belt ply and an outer belt ply located radially outward of the inner belt ply,
each end of the outer belt ply is located axially inward of an end of the inner belt ply,
the tread has a tread pattern including a plurality of circumferential grooves, thereby forming a plurality of land portions aligned in an axial direction in the tread,
the plurality of land portions include, in a portion between an equator plane of the tire and an end of the tread, a crown land portion located on the equator plane side, a shoulder land portion located on the tread end side, and a middle land portion located between the crown land portion and the shoulder land portion,
a proportion ARc of the cap layer occupying the crown land portion is represented as an average value of a ratio of a cap layer thickness to a base layer thickness in the crown land portion,
a proportion ARm of the cap layer occupying the middle land portion is represented as an average value of a ratio of a cap layer thickness to a base layer thickness in the middle land portion,
a proportion ARs of the cap layer occupying the shoulder land portion is represented as an average value of a ratio of a cap layer thickness to a base layer thickness in the shoulder land portion,
the cap layer proportion ARc of the crown land portion is not less than 1.5 and not greater than 3.5,
the cap layer proportion ARm of the middle land portion is equal to or higher than the cap layer proportion ARc of the crown land portion,
the cap layer proportion ARs of the shoulder land portion is higher than the cap layer proportion ARm of the middle land portion and not less than 5.0 and not greater than 9.5,
the base layer is tapered outward in the axial direction in the shoulder land portion, and
the tire has a nominal cross-sectional width of not less than 215 mm and not greater than 325 mm and a load index (LI) of not less than 90.

[17.] The tire according to above, wherein
of the two ends of the tread, one end located on an inner side in a width direction of a vehicle when the tire is mounted on the vehicle is a first reference end, and another end is a second reference end,
the first reference end side of the crown land portion with respect to the equator plane is a first portion, and the second reference end side of the crown land portion with respect to the equator plane is a second portion, and
a ratio of a width of the second portion to the width of the crown land portion is not less than 51% and not greater than 55%.

[18.] The tire according to or above, wherein
a hardness of the cap layer is not less than 60 and not greater than 70,
a hardness of the base layer is not less than 50 and not greater than 65, and
each end of the cap layer is axially outward of the end of the belt.

What is claimed is:

1. A tire comprising:
a pair of beads,
a carcass extending on and between the pair of beads,
a tread radially outward of the carcass, and
a belt between the tread and the carcass, wherein
the tread includes:
a base layer, and
a cap layer covering the entire base layer,
the cap layer is harder than the base layer,
a loss tangent at 70° C. of the base layer is lower than a loss tangent at 30° C. of the cap layer,
each end of the base layer is located axially inward of an end of the belt,
the belt includes an inner belt ply and an outer belt ply located radially outward of the inner belt ply,
each end of the outer belt ply is located axially inward of an end of the inner belt ply,
the tread has a tread pattern including a plurality of circumferential grooves, thereby forming a plurality of land portions aligned in an axial direction in the tread,
the plurality of land portions include, in a portion between an equator plane of the tire and an end of the tread, a crown land portion located on the equator plane side, a shoulder land portion located on the tread end side, and a middle land portion located between the crown land portion and the shoulder land portion,
a proportion ARc of the cap layer occupying the crown land portion is represented as an average value of a ratio of a cap layer thickness to a base layer thickness in the crown land portion,
a proportion ARm of the cap layer occupying the middle land portion is represented as an average value of a ratio of a cap layer thickness to a base layer thickness in the middle land portion,
a proportion ARs of the cap layer occupying the shoulder land portion is represented as an average value of a ratio of a cap layer thickness to a base layer thickness in the shoulder land portion,
the cap layer proportion ARc of the crown land portion is not less than 1.5 and not greater than 3.5,
the cap layer proportion ARm of the middle land portion is equal to or higher than the cap layer proportion ARc of the crown land portion, and
the cap layer proportion ARs of the shoulder land portion is higher than the cap layer proportion ARm of the middle land portion and not less than 5.0 and not greater than 9.5.

2. The tire according to claim 1, wherein a position of each end of the cap layer coincides with a position of the end of the belt in the axial direction, or each end of the cap layer is located axially outward of the end of the belt.

3. The tire according to claim 1, wherein
a ground-contact surface obtained when the tire is fitted onto a standardized rim, an internal pressure of the tire is adjusted to 250 kPa, a camber angle of the tire is set to 0 degrees, a vertical load is applied to the tire, and the tire is brought into contact with a road surface composed of a flat surface, is a standard ground-contact surface,
the vertical load applied to the tire is not less than 60% and not greater than 80% of a load indicated by a load index of the tire,
a ground-contact width of the standard ground-contact surface is not less than 70% and not greater than 80% of a nominal cross-sectional width of the tire, and
a ratio of a sum of groove widths of the plurality of circumferential grooves included in the standard ground-contact surface to the ground-contact width of the standard ground-contact surface is not less than 20% and not greater than 30%.

4. The tire according to claim 3, wherein
the tread pattern includes the four circumferential grooves, thereby forming the five land portions in the tread,
the five land portions are the crown land portion located on the equator plane, a pair of the middle land portions located axially outward of the crown land portion, and a pair of the shoulder land portions located axially outward of the respective middle land portions, and
a ratio of a width of the crown land portion to the ground-contact width of the standard ground-contact surface is not less than 14% and not greater than 16%.

5. The tire according to claim 4, wherein
of the two ends of the tread, one end located on an inner side in a width direction of a vehicle when the tire is mounted on the vehicle is a first reference end, and another end is a second reference end,
a width of the shoulder land portion on the first reference end side is not less than 90% and not greater than 100% of the width of the crown land portion,
a width of the middle land portion on the first reference end side is not less than 90% and not greater than 100% of the width of the crown land portion,
a width of the middle land portion on the second reference end side is not less than 97% and not greater than 107% of the width of the crown land portion, and
a width of the shoulder land portion on the second reference end side is not less than 114% and not greater than 124% of the width of the crown land portion.

6. The tire according to claim 4, wherein
the first reference end side of the crown land portion with respect to the equator plane is a first portion, and the second reference end side of the crown land portion with respect to the equator plane is a second portion, and
a ratio of a width of the second portion to the width of the crown land portion is not less than 51% and not greater than 55%.

7. The tire according to claim 1, wherein
the loss tangent at 70° C. of the base layer is not less than 0.02 and not greater than 0.10, and
the loss tangent at 30° C. of the cap layer is not less than 0.12 and not greater than 0.40.

8. The tire according to claim 1, wherein a ratio of the loss tangent at 30° C. of the base layer to the loss tangent at 70° C. of the cap layer is not less than 0.10 and not greater than 0.38.

9. The tire according to claim 1, wherein the base layer is tapered outward in the axial direction in the shoulder land portion.

10. The tire according to claim 1, wherein
the cap layer proportion ARc of the crown land portion is not less than 2.0 and not greater than 3.0, and/or
the cap layer proportion ARs of the shoulder land portion is higher than the cap layer proportion ARm of the middle land portion and not less than 7.0 and not greater than 9.0.

11. The tire according to claim 1, wherein the tire has a nominal cross-sectional width of not less than 215 mm and not greater than 325 mm and a load index (LI) of not less than 90.

12. The tire according to claim 1, wherein
groove depth of each circumferential groove is not less than 5.0 mm and not greater than 7.5 mm, and
groove width of each circumferential groove is not less than 5.0 mm and not greater than 20.0 mm.

13. The tire according to claim 1, wherein
a hardness of the cap layer is not less than 60 and not greater than 70, and
a hardness of the base layer is not less than 50 and not greater than 65.

14. The tire according to claim 1, wherein
a difference between a hardness of the cap layer and a hardness of the base layer is not less than 10 and not greater than 20.

15. The tire according to claim 1, wherein each end of the cap layer is axially outward of the end of the belt.

16. A tire comprising:
a pair of beads,
a carcass extending on and between the pair of beads,
a tread radially outward of the carcass, and
a belt between the tread and the carcass, wherein
the tread includes:
a base layer, and
a cap layer covering the entire base layer,
the cap layer is harder than the base layer,
a loss tangent at 70° C. of the base layer is lower than a loss tangent at 30° C. of the cap layer,
each end of the base layer is located axially inward of an end of the belt,
the belt includes an inner belt ply and an outer belt ply located radially outward of the inner belt ply,
each end of the outer belt ply is located axially inward of an end of the inner belt ply,
the tread has a tread pattern including a plurality of circumferential grooves, thereby forming a plurality of land portions aligned in an axial direction in the tread,
the plurality of land portions include, in a portion between an equator plane of the tire and an end of the tread, a crown land portion located on the equator plane side, a shoulder land portion located on the tread end side, and a middle land portion located between the crown land portion and the shoulder land portion,
a proportion ARc of the cap layer occupying the crown land portion is represented as an average value of a ratio of a cap layer thickness to a base layer thickness in the crown land portion,
a proportion ARm of the cap layer occupying the middle land portion is represented as an average value of a ratio of a cap layer thickness to a base layer thickness in the middle land portion,
a proportion ARs of the cap layer occupying the shoulder land portion is represented as an average value of a ratio of a cap layer thickness to a base layer thickness in the shoulder land portion,
the cap layer proportion ARc of the crown land portion is not less than 1.5 and not greater than 3.5,
the cap layer proportion ARm of the middle land portion is equal to or higher than the cap layer proportion ARc of the crown land portion,
the cap layer proportion ARs of the shoulder land portion is higher than the cap layer proportion ARm of the middle land portion and not less than 5.0 and not greater than 9.5,
the base layer is tapered outward in the axial direction in the shoulder land portion, and
the tire has a nominal cross-sectional width of not less than 215 mm and not greater than 325 mm and a load index (LI) of not less than 90.

17. The tire according to claim 16, wherein
of the two ends of the tread, one end located on an inner side in a width direction of a vehicle when the tire is mounted on the vehicle is a first reference end, and another end is a second reference end,
the first reference end side of the crown land portion with respect to the equator plane is a first portion, and the second reference end side of the crown land portion with respect to the equator plane is a second portion, and
a ratio of a width of the second portion to the width of the crown land portion is not less than 51% and not greater than 55%.

18. The tire according to claim 16, wherein
a hardness of the cap layer is not less than 60 and not greater than 70,
a hardness of the base layer is not less than 50 and not greater than 65, and
each end of the cap layer is axially outward of the end of the belt.
